(19) United States
(12) Patent Application Publication
(10) Pub. No.: US 2024/0249491 A1
(43) Pub. Date: Jul. 25, 2024

(54) SYSTEM AND METHOD FOR OBJECT RECOGNITION UTILIZING REFLECTIVE LIGHT BLOCKING

(71) Applicants: BASF COATINGS GMBH, Munster (DE); SRI INTERNATIONAL, Menlo Park, CA (US)

(72) Inventors: Matthew Ian CHILDERS, Southfield, MI (US); Yunus Emre KURTOGLU, Southfield, MI (US); David BERENDS, Skillman, NJ (US); Gregory W. FARIS, Menlo Park, CA (US); Garbis SALGIAN, Princeton Junction, NJ (US); Michael PIACENTINO, Robbinsville, NJ (US)

(21) Appl. No.: 18/560,019

(22) PCT Filed: May 11, 2022
(86) PCT No.: PCT/EP22/62797

§ 371 Date: Nov. 9, 2023

Related U.S. Application Data
(60) Provisional application No. 63/193,299, filed on May 26, 2021.

(51) Int. Cl. G06V 10/145; G06V 10/141; G06V 10/143; G06V 10/74; G06V 10/88; G06V 20/80

(52) U.S. Cl. CPC G06V 10/145; G06V 10/141; G06V 10/143; G06V 10/761; G06V 10/895; G06V 20/80

(57) ABSTRACT

Disclosed herein are methods and systems for object recognition utilizing reflective light blocking. Further disclosed herein are systems and methods for recognition of at least one fluorescent object being present in a scene by using a light source including at least one illuminant and a bandpass filter for each illuminant of the light source, a sensor array including at least one light sensitive sensor and at least one filter selectively blocking the reflected light originating from illuminating the scene with the light source and allowing passage of luminescence originating from illuminating the scene with the light source into the at least one color sensitive sensor, and a processing unit for identifying the at least one object based on the data detected by the sensory array and known data on luminescence properties associated with known objects.

### FIELD

Aspects described herein generally relate to methods and systems for object recognition utilizing reflective light blocking. More specifically, aspects described herein relate to systems and methods for recognition of at least one fluorescent object being present in a scene by using a light source comprising at least one illuminant, a sensor array including at least one light sensitive sensor and at least one filter selectively blocking the reflected light originating from illuminating the scene with the light source and allowing passage of luminescence originating from illuminating the scene with the light source into the at least one color sensitive sensor, and a processing unit for identifying the at least one object based on the data detected by the sensory array and known data on luminescence properties associated with known objects. The physical separation of fluorescent and reflected light originating from illumination of the scene by use of the camera filter allows to perform object recognition under varying geometries of the scene to the camera and the light source, thus improving the operability under real world conditions.

### BACKGROUND

Computer vision is a field in rapid development due to abundant use of electronic devices capable of collecting information about their surroundings via sensors such as cameras, distance sensors such as LIDAR or radar, and depth camera systems based on structured light or stereo vision to name a few. These electronic devices provide raw image data to be processed by a computer processing unit and consequently develop an understanding of an environment or a scene using artificial intelligence and/or computer assistance algorithms. There are multiple ways how this understanding of the environment can be developed. In general, 2D or 3D images and/or maps are formed, and these images and/or maps are analysed for developing an understanding of the scene and the objects in that scene. The object identification process has been termed remote sensing, object identification, classification, authentication, or recognition over the years. While shape and appearance of objects in the environment acquired as 2D or 3D images can be used to develop an understanding of the environment, these techniques have some shortcomings. One prospect for improving computer vision is to identify objects based on the chemical components present on the objects in the scene.

A number of techniques have been developed for recognition of an object in computer vision systems and include, for example, the use of image-based physical tags (e.g. barcodes, QR codes, serial numbers, text, patterns, holograms etc.) or scan-/close contact-based physical tags (e.g. viewing angle dependent pigments, upconversion pigments, metachromics, colors (red/green), luminescent materials). However, the use of image-based physical tags is associated with some drawbacks including (i) reduced readability in case the object comprising the image-based physical tag is occluded, only a small portion of the object is in view or the image-based physical tag is distorted, and (ii) the necessity to furnish the image-based physical tag on all sides of the object in large sizes to allow recognition from all sides and from a distance. Scanning and close contact-based tags also have drawbacks. Upconversion pigments are usually opaque and have large particles sizes, thus limiting their use in coating compositions. Moreover, they require strong light probes because they only emit low levels of light due to their small quantum yields. Many upconversion pigments have unique response times that are used for object recognition and classification, however, the measurement of the response time requires knowing the distance between the probe and the sample in order to calculate the time of flight for the light probe. This distance is, however, rarely known in computer vision applications. Similarly, viewing angle dependent pigment systems only work in close range and require viewing at multiple angles. Also, the color is not uniform for visually pleasant effects. The spectrum of incident light must be managed to get correct measurements. Within a single image/scene, an object that has angle dependent color coating will have multiple colors visible to the camera along the sample dimensions. Color-based recognitions are difficult because the measured color depends partly on the ambient lighting conditions. Therefore, there is a need for reference samples and/or controlled lighting conditions for each scene. Different sensors will also have different capabilities to distinguish different colors and will differ from one sensor type/maker to another, necessitating calibration files for each sensor. Luminescence based recognition under ambient lighting is a challenging task, as the reflective and luminescent components of the object are added together. Typically, luminescence-based recognition will instead utilize a dark measurement condition and a priori knowledge of the excitation region of the luminescent material so the correct light probe/source can be used.

Another technique utilized for recognition of an object in computer vision is the use of passive or active electronic tags. Passive electronic tags are devices which are attached to objects to be recognized without requiring to be visible or to be supplied with power, and include, for example, RFID tags. Active electronic tags are powered devices attached to the object(s) to be recognized which emit information in various forms, such as wireless communications, light, radio, etc. Use of passive electronic tags, such as RFID tags, require the attachment of a circuit, power collector, and antenna to the item/object to be recognized or the object recognition system to retrieve information stored on the tag, adding cost and complication to the design. To determine a precise location when using passive electronic tags, multiple sensors have to be used in the scene, thus further increasing the costs. Use of active electronic tags require the object to be recognized to be connected to a power source, which is cost-prohibitive for simple items like a soccer ball, a shirt, or a box of pasta and is therefore not practical.

Yet another technique utilized for recognition of an object in computer vision is the image-based feature detection relying on known geometries and shapes stored in a database or image-based deep learning methods using algorithms which have been trained by numerous labelled images comprising the objects to be recognized. A frequent problem associated with image-based feature detection and deep learning methods is that the accuracy depends largely on the quality of the image and the position of the camera within the scene, as occlusions, different viewing angles, and the like can easily change the results. Moreover, detection of flexible objects that can change their shape is problematic as each possible shape must be included in the database to allow recognition. Furthermore, the visual parameters of the object must be converted to mathematical parameters at great effort to allow usage of a database of known geometries and shapes. Additionally, logo type images present a challenge since the can be present in multiple places within the scene (i.e., a logo can be on a ball, a T-shirt, a hat, or a coffee mug) and the object recognition is by inference. Finally, there is always inherent ambiguity as similarly shaped objects may be misidentified as the object of interest. In case of image-based deep learning methods, such as CNNs, the accuracy of the object recognition is dependent on the quality of the training data set and large amounts of training material are needed for each object to be recognized/classified.

Finally, object tracking methods are used for object recognition. In such methods, items in a scene are organized in a particular order and labelled. Afterwards, the objects are followed in the scene with known color/geometry/3D coordinates. However, “recognition” is lost if the object leaves the scene and re-enters.

Apart from the above-mentioned shortcomings, these methods all lack the possibility to identify as many objects as possible within each scene with high accuracy and low latency using a minimum amount of resources in sensors, computing capacity, light probe etc.

Performing object recognition under real world conditions, i.e. in under ambient lightning conditions, is one further challenge that was recently addressed by some methods and systems. These methods and systems combine specialized light probes necessary for recognition of objects by the object recognition system with the need for visually pleasant ambient lighting into a single lighting device. The use of such combined light sources, however, renders it necessary to separate—from the radiance of the scene detected by hyperspectral cameras upon illumination of the scene with the light source—the reflected light from the fluoresced light to render object recognition possible. In the known methods and systems, this separation is achieved by computational methods in which the radiance of the scene under different lighting conditions using a hyperspectral camera is measured and the measured radiance is compared to the expected radiance under each lighting condition. While such methods and systems work well in a laboratory setting, there are many challenges to implementing them in real world conditions, including the high cost (˜$10 ks), the limited frame rate of hyperspectral cameras and the difficulty of knowing the expected radiance of each lighting condition, which varies based on the geometry of the scene to the lighting and the camera.

It would therefore be desirable to provide systems and methods for recognition of fluorescent object(s) in a scene which are not associated with the aforementioned drawbacks. More specifically, the systems and computer-implemented methods for recognition of fluorescent object(s) in a scene should use a combined light source, i.e. a light source comprising specialized light probes but providing, at the same time, visually pleasant ambient lightning, but should be implemented at low costs and without having to rely on the use of known or expected parameters to separate the reflectance from the fluorescence, thus improving their operability under real world conditions. Moreover, the systems and methods should result in high accuracy and low latency of object recognition using a reduced amount of resources in sensors and computing capacity.

### Definitions

“Object recognition” refers to the capability of a system to identify an object in a scene, for example by using any of the aforementioned methods, such as analysing a picture with a computer and identifying/labelling a ball in that picture, sometimes with even further information such as the type of a ball (basketball, soccer ball, baseball), brand, the context, etc..

“Ambient lightning” (also known as “general lighting” in the trade) refers to sources of light that are already available naturally (e.g. the sun, the moon) or artificial light used to provide overall illumination in an area utilized by humans (e.g. to light a room). In this context, “ambient light source” refers to an artificial light source that affects all objects in the scene and provides a visually pleasant lighting of the scene to the eyes of an observer without having any negative influences on the health of the observer.

“Object having object specific reflectance and/or luminescence properties” refers to objects having reflectance and/or luminescence properties due to the presence of at least one luminescence material on at least part of the surface of the object.

“Full-width-half-max” (FWHM) of an illuminant is the width of the emission spectrum curve of the illuminant measured between those points on the y-axis which are half the maximum amplitude.

“Digital representation” may refer to a representation of a pre-defined object, e.g. a known object, in a computer readable form. In particular, the digital representation of pre-defined objects may, e.g. be data on object specific reflectance and/or luminescence properties. Such data may comprise RGB values, rg chromacity values, spectral luminescence and/or reflectance patterns or a combination thereof. The data on object specific luminescence and/or reflectance properties may be associated with the respective object to allow identification of the object upon determining the object specific reflectance and/or luminescence properties.

“Color sensitive sensor” refers to a sensor being able to detect color values, such as RGB values, or spectral information of the scene in the field of vision o the sensor.

“Communication interface” may refer to a software and/or hardware interface for establishing communication such as transfer or exchange or signals or data. Software interfaces may be e.g. function calls, APIs. Communication interfaces may comprise transceivers and/or receivers. The communication may either be wired, or it may be wireless. Communication interface may be based on or it supports one or more communication protocols. The communication protocol may a wireless protocol, for example: short distance communication protocol such as Bluetooth®, or WiFi, or long distance communication protocol such as cellular or mobile network, for example, second-generation cellular network (“2G”), 3G, 4G, Long-Term Evolution (“LTE”), or 5G. Alternatively, or in addition, the communication interface may even be based on a proprietary short distance or long distance protocol. The communication interface may support any one or more standards and/or proprietary protocols.

“Computer processor” refers to an arbitrary logic circuitry configured to perform basic operations of a computer or system, and/or, generally, to a device which is configured for performing calculations or logic operations. In particular, the processing means, or computer processor may be configured for processing basic instructions that drive the computer or system. As an example, the processing unit or computer processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processing unit, or computer processor may be a multicore processor. Specifically, the processing unit, or computer processor may be or may comprise a Central Processing Unit (“CPU”). The processing unit or computer processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing unit may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processing unit or processor may also refer to one or more processing devices, such as a distributed system of processing devices located across multiple computer systems (e.g., cloud computing), and is not limited to a single device unless otherwise specified.

### SUMMARY

To address the above-mentioned problems in a perspective the following is proposed:

a system for object recognition, said system comprising:
a light source configured to illuminate a scene in which at least one object having object specific reflectance and/or luminescence properties is present, wherein the light source comprises at least one illuminant;
a sensor unit for acquiring data on object specific reflectance and/or luminescence properties upon illumination of the scene by the light source for each object having object specific reflectance and/or luminescence properties and being present in the scene, wherein the sensor unit includes at least one color sensitive sensor and at least one camera filter selectively blocking the reflected light and allowing passage of reflectance and/or luminescence originating from illuminating the scene with the light source into the at least one color sensitive sensor, the at least one camera filter being positioned optically intermediate the scene and the color sensitive sensor(s);
a data storage medium comprising a plurality of digital representations of pre-defined objects;
and a processing unit in communication with the sensor unit and the light source, the processing unit programmed to:
   optionally determine further object specific luminescence properties from the acquired data on object specific reflectance and/or luminescence properties, and
   determine the object(s) based on
      the data acquired on object specific reflectance and/or luminescence properties and/or the determined further object specific reflectance and/or luminescence properties and
      the digital representations of pre-defined objects.

It is an essential advantage of the system according to the present invention that the separation of reflected and fluorescent light upon illumination of the scene with a light source, preferably an ambient light source, is performed physically instead of computationally, thus rendering the system suitable for varying geometries of the scene to the light source and the sensor array. Moreover, the system requires less computing power because the separation of reflected and fluorescent light is performed physically by the use of camera filters before color sensitive sensor(s) of the sensor unit which are adapted to the emitted spectral light of each illuminant of the light source. Additionally, the inventive system can operate under real world conditions using ambient lighting by subtracting data of the scene acquired under ambient light from data of the scene acquired under ambient light and illumination from the light source. To mitigate that the captured data vary greatly due to the flickering (so-called duty cycle) of the illuminants present in the scene, the inventive system may comprise a control unit which synchronizes the color sensitive sensor(s) acquiring the data to the duty cycle of the illuminants present in the scene. This allows for the inventive system to compensate for the changes occurring in the acquired images due to the ambient light changes, thus rendering object recognition possible under ambient lightning instead of using highly defined illumination conditions, such as dark rooms, unpleasant lightning conditions, such as IR lightning conditions, or lightning conditions with adverse health effects or that are detrimental to common items, such as significant levels of UV lighting.

Further disclosed is:

a computer-implemented method for recognizing at least one object having specific luminescence properties in a scene, the method comprising:
(i) illuminating—with a light source comprising at least one illuminant—the scene in which the least one object having object specific reflectance and/or luminescence properties is present;
(ii) acquiring—with a sensor unit—data on the object specific reflectance and/or luminescence properties upon illuminating the scene with the light source for each object having object specific reflectance and/or luminescence properties and being present in the scene, wherein the sensor unit includes at least one color sensitive sensor and at least one camera filter selectively blocking the reflected light and allowing passage of reflectance and/or luminescence originating from illuminating the scene with the light source into the at least one color sensitive sensor, the at least one camera filter being positioned optically intermediate the scene and the sensor(s);
(iii) optionally determining—with a computer processor—further object specific reflectance and/or luminescence properties from the data acquired in step (ii);
(iv) providing to the computer processor via a communication interface digital representations of pre-defined objects;
(v) determining—with the computer processor—the object(s) based on data acquired on object specific reflectance and/or luminescence properties and/or the optionally determined further object specific reflectance and/or luminescence properties and the provided digital representations of pre-defined objects, and
(vi) optionally providing via a communication interface the determined object(s).

The inventive method achieves physical separation of reflected and fluorescent light, thus allowing object recognition under varying geometries of the scene to the light source and the sensor array. Moreover, the method can be performed under ambient lightning conditions because the method allows to subtract data of the scene acquired under ambient light from data of the scene acquired under ambient light and illumination from the light source by synchronizing the color sensitive sensor(s) acquiring the data to the flickering the illuminants present in the scene, thus preventing that the contribution of ambient light in the acquired data varies. This allows to compensate the changes occurring in the acquired data due to the ambient light changes (i.e. flickering cycle) and renders it possible to perform the inventive method in combination with ambient lightning conditions, such as real-world conditions.

Further disclosed is:

A non-transitory computer-readable storage medium, the computer-readable storage medium including instructions that when executed by a computer, cause the computer to perform the steps according to the computer-implemented method described herein.

The disclosure applies to the systems, methods and non-transitory computer-readable storage media disclosed herein alike. Therefore, no differentiation is made between systems, methods and non-transitory computer-readable storage media. All features disclosed in connection with the systems are also valid for the methods and non-transitory computer-readable storage media disclosed herein.

Further disclosed is a system comprising a scene and at least identified object, wherein the object was recognized using the system or the method disclosed herein.

Further disclosed is the use of the system or the method disclosed herein for identifying objects having object specific reflectance and/or luminescence properties in a scene.

### EMBODIMENTS

### Embodiments of the Inventive Object Recognition System:

The inventive object recognition system is used to detect at least one object having object specific reflectance and/or luminescence properties which is present in the scene monitored by the object recognition system. Luminescence is the property of light being emitted from a material without heat. A variety of luminescence mechanisms, such as chemiluminescence, mechanoluminescence, and electroluminescence are known. Photoluminescence is the emission of light/photons due to the absorption of other photons. Photoluminescence includes fluorescence, phosphorescence, upconversion, and Raman scattering. Photoluminescence, fluorescence and phosphorescence are able to change the color appearance of an object under ordinary light conditions. While there is a difference between the chemical mechanisms and time scales of fluorescence and phosphorescence, for most computer vision systems they will appear identical.

Some objects are naturally luminescent and can therefore be directly recognized with the proposed system and/or method without further modification of the object.

In case the object is not naturally luminescent, the luminescence has to be imparted. Such objects having object specific luminescence and reflectance properties comprise at least one luminescence material, each luminescence material having a predefined luminescence property. The object can be imparted with the at least one luminescence material by a variety of methods. In one example, luminescent material(s) are dispersed in a coating material which is applied by spray coating, dip coating, coil coating, roll-to-roll coating and other application methods. After optional drying, the applied coating material is cured to form a solid and durable luminescence coating layer on the object surface. In another example, the luminescence material(s) are printed onto the surface of the object. In yet another example, the luminescence material(s) are dispersed into a composition and the composition is afterwards extruded, molded, or casted to obtain the respective object. Other examples include genetical engineering of biological materials (vegetables, fruits, bacteria, tissue, proteins, etc.) or the addition of luminescent proteins in any of the ways mentioned herein. Since the luminescence spectral pattern of the luminescence material(s) are known, these luminescent material(s) can be used as an identification tag by interrelating the object comprising said luminescence material(s) with the respective luminescence spectral pattern(s). By using luminescent chemistry of the object as a tag, object recognition is possible irrespective of the shape of the object or partial occlusions.

Suitable luminescent materials are commercially available, and their selection is mainly limited by the durability of the fluorescent materials and compatibility with the material of the object to be recognized. Preferred examples of luminescene materials include fluorescent materials, for example the BASF Lumogen® F series of dyes, such as, for example, yellow 170, orange 240, pink 285, red 305, a combination of yellow 170 and orange 240 or any other combination thereof. Another example of suitable fluorescent materials are Clariant Hostasol® fluorescent dyes Red GG, Red 5B, and Yellow 3G. Optical brighteners are a class of fluorescent materials that are often included in object formulations to reduce the yellow color of many organic polymers.

They function by fluorescing invisible ultraviolet light into visible blue light, thus making the produced object appear whiter. Many optical brighteners are commercially available, including BASF Tinopal® SFP and Tinopal® NFW and Clariant Telalux® KSI and Telalux® OB1.

The first essential component of the inventive system is a light source configured to illuminate the scene in which at least one object having object specific reflectance and/or luminescence properties is present. The light source comprises at least one illuminant. In one example, the light source of the inventive system is not part of the ambient lightning of the room. In another example, the light source of the inventive system is part of the ambient lightning of the room and may act as the primary or secondary ambient light source in the room. The scene can be located indoors as well as outdoors, i.e. object recognition with the inventive system can be performed indoors as well as outdoors.

In an aspect, the light source comprises at least 2 different illuminants and is configured to illuminate the scene by switching between the illuminants of the light source. Suitable light sources comprise 2 to 20 different illuminants, more preferably 3 to 12 different illuminants, in particular 4 to 10 different illuminants. If more than 3 illuminants are present in the light source, the switching can either be performed such that exactly one illuminant is switched on at a time or that more than one illuminant is switched on at a time (with the proviso that not all illuminants of the light source are switched on at the same time).

In principle, the illuminant(s) of the light source can be commonly known illuminants, such as illuminants comprising at least one LED (LED illuminants), illuminants comprising at least one incandescent illuminant (incandescent illuminants), illuminants comprising at least one fluorescent illuminant (fluorescent illuminants) or a combination thereof. According to a preferred embodiment, the at least one illuminant is an illuminant comprising or consisting of at least one LED, in particular at last one narrowband LED. With particular preference, all illuminants of the light source are illuminants comprising or consisting of at least one LED, in particular at least one narrowband LED. “Narrowband LED” may refer to an individual color LED (i.e. an LED not having a white output across the entire spectrum) having a full-width-half-max (FWHM)—either after passing through the bandpass filter or without the use of a bandpass filter—as listed below. Use of LED illuminants reduces the adverse effects on the health which can be associated with the use of fluorescent lights as previously described. Moreover, use of LED illuminants also has various advantages over the use of illuminants comprising incandescent lights: firstly, they allow fast switching between the illuminants of the light source, thus allowing faster acquisition times of the scene under various illumination conditions and therefore also faster object recognition. Secondly, LED illuminants require less energy compared to incandescent illuminants for the same amount of in band illumination, thus allowing to use a battery driven object recognition system. Thirdly, LED illuminants require less amount of time to achieve a consistent light output and a steady state operating temperature, thus the object recognition system is ready faster. Fourthly, the lifetime of LED illuminants is much higher, thus requiring reduced maintenance intervals. Fifthly, the FWHD of the LED illuminants is narrow enough such that the use of a bandpass filter is not necessary, thus reducing the complexity of the system and therefore the overall costs.

In an aspect, each illuminant of the light source has a full-width-half-max (FWHM) of 5 to 60 nm, preferably of 3 to 40 nm, more preferably of 4 to 30 nm, even more preferably of 5 to 20 nm, very preferably of 8 to 20 nm. If an LED illuminant comprising more than one LED is used, each LED of the LED illuminant preferably comprises the aforementioned FWHM. The FWHM of each illuminant is obtained from the emission spectrum of each illuminant and is the difference of each wavelength at half of the maximum values of the emission spectrum. Illuminants having a FWHM in the claimed range emit spectral light only in a very defined wavelength range. This allows to match the camera filter(s) more easily to the emitted spectral light of each illuminant of the light source such that physical separation of fluorescent and reflected light is achieved by the matching camera filter(s).

In one example, the FWHD previously stated can be achieved by using an illuminant bandpass filter positioned directly in front of each illuminant and being selected such that the FWHD of each illuminant after passing through the bandpass filter is within the claimed range. In case the illuminant comprises or consists of more than one LED, a respective bandpass filter is preferably used for each LED of the illuminant. In another example, the FWHD previously stated is achieved by using illuminants each already having an FWHD in the claimed range. In case the illuminant comprises or consists more than one LED each LED preferably has an FWHD in the claimed range. With particular preference, a bandpass filter positioned directly in front of each illuminant is used to achieve the claimed FWHD for each illuminant.

In an aspect, the at least one illuminant, in particular all illuminants, have a peak center wavelength in the range of 385 to 700 nm. In case of the illuminants comprises or consists more than one LED, it may be preferred if each LED of the illuminant has a peak center wavelength in the aforementioned range. Use of illuminants having the aforementioned peak center wavelength renders it possible to use the light source of the inventive system as a primary or secondary ambient light source in a room. This allows to perform object recognition under ambient lightning conditions without the necessity to use defined lighting conditions (such as dark rooms) and to easily integrate the object recognition system into the ambient lightning system already present in the room without resulting in unpleasant lightning conditions in the room.

The light source may further include further includes diffuser and/or focusing optics. In one example, the light source comprises separate diffuser and/or focusing optics for each illuminant of the light source. In case of LED illuminants, single focusing and diffuser optics may be used for all LEDs of the LED illuminant. Suitable focusing optics comprise an individual frosted glass for each illuminant of the light source. In another example, the light source comprises a single diffuser and/or focusing optic for all illuminants of the light source.

The second essential component of the inventive system is a sensor unit a sensor unit for acquiring data on object specific reflectance and/or luminescence properties for each object having object specific reflectance and/or luminescence properties and being present in the scene upon illumination of the scene by the light source. The sensor unit includes at least one color sensitive sensor and at least one camera filter positioned optically intermediate the scene and the color sensitive sensor(s). The at least one camera filter is used to selectively block the reflected light and allowing passage of luminescence originating from illuminating the scene with the light source into the at least one color sensitive sensor. This allows to physically separate reflectance from fluorescence which is necessary to identify an object in the scene based on the detected reflectance and/or luminescence properties.

In an aspect, data acquired on object specific reflectance and/or luminescence properties comprises or consists of RGB values, wavelength dependent radiation intensities or a combination thereof.

Suitable color sensitive sensor(s) include RGB color cameras, multispectral cameras or hyperspectral cameras, in particular from RGB color cameras.

In an aspect, the sensor unit includes two color sensitive sensors selected from RGB color cameras, multispectral cameras, hyperspectral cameras or any combination thereof, in particular from two RGB color cameras.

Each camera filter of the sensor unit may be matched to spectral light emitted by the illuminant(s) of the light source. This allows to block the reflective light originating from illuminating the scene with the respective illuminant from the fluorescent light originating from illuminating the scene with the respective illuminant.

In one example, each color sensitive sensor comprises a camera filter. Suitable camera filters to be used within this example include multi-bandpass filters which are complementary to each other. Multi-bandpass filters are complementary to each other if the transmission valleys and peaks of these multi-bandpass filters are complementary to each other. The multi-bandpass filter(s) may have a high out-of-band light rejection to effectively block the reflective light from the fluorescent light.

In another example, the sensor unit comprises a single camera filter for all color sensitive sensors present in the sensor unit. Suitable single camera filters include multi-dichroic beam splitters.

The sensor unit may further contain collection optics positioned optically intermediate the camera filter and each color sensitive sensor of the sensor unit or positioned optically intermediate the camera filter of each color sensitive sensor of the sensor unit and the scene. The collection optics enable efficient collection of the reflected and fluorescent light upon illumination of the scene with the light source and thus increase the accuracy of the object recognition system.

The third essential component of the inventive system is a data storage medium comprising a plurality of digital representations of pre-defined objects. In one example, the data storage medium may be present within the processing unit, for example as internal storage. In another example, the data storage medium is present outside the processing unit, for example as an external database which can be accessed by the processing unit via a communication interface. The latter may be preferred with respect to the storage capacity and updating the digital representations stored on said data storage medium because the use of an external database allows to reduce the capacity of the internal storage of the processing unit and to update the stored data more easily because one central database can be used for several object recognition systems. Thus, only one database has to be updated instead the internal memory of several object recognition systems.

The digital representation of each pre-defined object stored on the data storage medium preferably comprises pre-defined object specific reflectance and/or luminescence properties optionally associated with the respective object. This allows to identify the respective object based on the object-specific reflectance and/or luminescence properties stored in the database, for example by determining the object specific reflectance and/or luminescence properties of the object(s) present in the scene and comparing the determined data to the data present on the data storage medium using matching algorithms.

The fourth essential component of the inventive system is a processing unit which is programmed to detect at least one object having object specific reflectance and/or luminescence properties being present in the scene. The processing unit detects the object(s) using the digital representation(s) of pre-defined objects stored on the data storage medium and the data acquired by the sensor unit or acquired data which was further processed by the processing unit prior to detecting the at least one object. The further processing is generally optional but may result in a higher object recognition accuracy, especially under ambient lightning conditions as described hereinafter.

Processing of the data acquired by the sensor unit may include determining further object specific reflectance and/or luminescence properties from the acquired data by
generating differential data by subtracting data of the scene acquired by at least one color sensitive sensor under ambient lightning and data of the scene acquired by at least one color sensitive sensor under ambient lightning and illumination by the light source, determining the regions of luminescence in the generated differential data and
transforming the RGB values of the differential data into rg chromacity values or
determining the luminescence spectral pattern and/or the reflective spectral pattern for the determined regions of luminescence.

Since the inventive object recognition system only blocks the reflective light from its own narrowband excitation LED illuminators and the corresponding portions of the ambient lighting but not all of the reflective light from a white light source used as artificial ambient light source in a room, the object specific reflectance and/or luminescence properties caused by the use of the light source of the inventive system cannot be detected directly. This problem may be circumvented by using highly defined illumination conditions (such as a dark room), which however, is not practical if the system is to be used under real-life conditions.

Another option is the use of the so-called delta-calculation, i.e. subtracting data collected under the ambient lighting from data collected under ambient lighting and illumination with the light source of the inventive system. The data necessary for performing the delta-calculation can be obtained, for example, by synchronizing the illuminant(s) of the light source and the color sensitive sensor(s) of the sensor unit such that the acquisition duration (i.e. the time each color sensitive sensor is switched on) of at least one color sensitive sensor of the sensor unit and the illumination duration (i.e. the time each illuminant is switched on) of each illuminant of the light source only overlap partially, i.e. at least one color sensitive sensor is switched on during a time where no illuminant of the light source is switched on, thus allowing to acquire data of the scene under illumination conditions being devoid of the illumination contributed by the light source of the inventive object recognition system. The delta-calculation, i.e. data (light source illumination+ambient lighting conditions)—data (ambient lighting conditions) results in data only containing information on the object specific reflectance and/or luminescence properties which is due to the illumination of the scene with the light source of the inventive system. However, for this data to be accurate, both sets of data must be recorded with the same contribution from ambient lighting. Flickering (i.e. the variation of brightness of a light source depending on the type of lighting, the duty cycle of the lighting, and the type of electrical power supplied to the lighting) of light sources which is commonly observed is therefore a problem, especially if the sensor's acquisition duration (exposure time) is short. In the worst case, when the acquisition duration is very short compared with the flicker cycle and the flicker goes from bright (100% on) to fully dark (0% on), the ambient light contribution can vary by 100% depending on when in the flicker cycle the acquisition begins. To mitigate this effect, the illuminant(s) and sensor(s) of the inventive system are synchronized and are switched on and off at defined time points as described later on. This allows to use the inventive object recognition system in combination with white light sources, i.e. under real-world conditions, because the accuracy of the object recognition is no longer dependent on the use of highly defined lightning conditions (such as dark rooms).

After generating the differential image, regions of luminescent are determined in the generated differential image to determine the regions to analyze and classify as containing luminescent object(s). This may be performed by analyzing the brightness of the pixels acquired with the luminescence channel (i.e. the color sensitive sensor of the sensor unit which only acquired the luminescence of the object when illuminated by the respective illuminant of the light source) because non-luminescent regions are black while luminescent regions, when illuminated by a suitable illuminant of the light source, will have some degree of brightness. In one example, the analysis can be performed by using a mask to block out black (i.e. non-luminescent regions). In another example, an edge detector can be used to mark any region above a certain brightness under any illuminant as being part of the luminescent region. It is also possible to combine the mask and the edge detector.

In case an RGB color camera is used as color sensitive senor, rg chromaticity values can be obtained from the RGB values of the differential data by using the following equations (1) and (2)

$$r = \frac{R}{( R + G + B )} \qquad ( 1 )$$

$$g = \frac{G}{( R + G + B )} \qquad ( 2 )$$

In case a multispectral or hyperspectral camera is used as color sensitive sensor, the luminescence pattern and/or the reflective pattern can be determined from the differential data in a similar way than previously described for the rg chromaticity values. For example, the luminescence pattern can be determined from the spectral pattern acquired by the luminescence channel (i.e. the color sensitive sensor of the sensor unit only acquiring luminescence of the object upon illumination of the scene with the light source). The reflective pattern and luminescence pattern can be determined from the spectral pattern acquired by the reflectance and luminescence channel (i.e. the color sensitive sensor of the sensor unit acquiring reflectance and luminescence of the object upon illumination of the scene with the light source). These spectral patterns can be magnitude normalized to give a measurement of chroma similar to the rg chromaticity values from the color cameras.

In an aspect, the processing unit is programmed to determine the object(s) based on the acquired data and/or the processed data and the digital representations of pre-defined objects by calculating the best matching reflectance and/or luminescence properties and obtaining the object(s) assigned to the best matching reflectance and/or luminescence properties. Calculating the best matching reflectance and/or luminescence properties may include applying any number of matching algorithms on the acquired data and/or the processed data and the digital representations of pre-defined objects stored on the data storage medium. Suitable the matching algorithms include nearest neighbors, nearest neighbors with neighborhood component analysis, neural network algorithms or a combination thereof. In one example, obtaining the object(s) assigned to the best matching reflectance and/or luminescence properties may include retrieving the object(s) associated with the best matching reflectance and/or luminescence properties from the digital representations of the pre-defined objects stored on the data storage medium. This may be preferred if the digital representations of pre-defined objects contain reflectance and/or luminescence properties interrelated with the respectively assigned object. In another example, obtaining the object(s) assigned to the best matching reflectance and/or luminescence properties may include searching a database for said object(s) based on the determined best matching reflectance and/or luminescence properties. This may be preferred if the digital representation of pre-defined objects only contains reflectance and/or luminescence properties but no further information on the object assigned to this properties. The further database may be connected to the processing unit via a communication interface.

In an aspect, the processing unit is programmed to determine the synchronization of the at least one illuminant of the light source and the least one color sensitive sensor of the sensor unit. The determination described in the following may, however, be performed for any combination of a light source comprising at least one illuminant and a sensor unit comprising at least one sensor that is required to be synchronized, for example in further object recognition systems requiring the use of a synchronized sensor unit/light source combination to detect objects being present in the scene based on luminescence and/or reflectance properties of these objects, and is not particularly restricted to the light source and sensor unit described herein. Moreover, the determination may also be performed with a further processing unit (i.e. a processing unit being separate from the processing unit of the inventive system) and may be provided to the processing unit and/or the control unit described later on via a communication interface.

Determining the synchronization of the at least one illuminant of the light source and the least one color sensitive sensor of the sensor unit may comprise the following steps:
(a) providing a digital representation of the light source and the sensor unit via a communication interface to the computer processor,
(b) determining—with a computer processor—the flicker cycle of all illuminants present in the scene,
(c) determining—with the computer processor—the illumination durations for each illuminant of the light source based on the provided digital representations,
(d) determining—with the computer processor—the acquisition durations for each sensor of the sensor unit based on the provided digital representations, determined illumination duration and optionally the determined flicker cycle, and
(e) determining—with the computer processor—the illumination time points for each illuminant of the light source and the acquisition time points for each sensor of the sensor unit based on the data determined in step (d) and optionally in step (b), and
(f) optionally providing the data determined in step (e) via a communication interface.

In step (a), digital representations of the light source as well as the sensor unit are provided via a communication interface to the computer processor. The digital representations may refer to representation of the light source and the sensor unit in a computer readable form. The digital representation of the light source may, for example, contain the number of illuminants, data on the wavelength of each illuminant of the light source, the type of each illuminant, the FWHM of each illuminant, illuminant bandpass filters or a combination thereof. The digital representation of the sensor unit may, for example, contain the number of color sensitive sensors, the type of each sensor, the resolution of each sensor, the frame rate of each sensor, the sensitivity of each senor or a combination thereof.

Step (b) may be performed according to various methods. In one example, the flicker cycle may be determined using a flicker detection system, for example a commercially available flicker detection system AMS TCS3408 Color Sensor from ams AG. In another example, determination of the flicker cycle may be performed according to methods commonly known in the state of the art, for example as described in US 2015/0163392 A1, US 2002/0097328 A1 and D. Poplin, “An automatic flicker detection method for embedded camera systems,” IEEE Transactions on Consumer Electronics, vol. 52, no. 2, pages 308 to 311, May 2006, doi: 10.1109/TCE.2006.1649642.

The illumination duration for each illuminant or for each LED of the illuminant may be determined based on the sensitivity of each color sensitive sensor for the respective illuminant or LED and on the type of data acquired upon illumination of the scene with the respective illuminant or the respective LED of the illuminant. This may include defining the type of data that is to be acquired with each respective sensor for each illuminant or for each LED of the illuminant. The type of data acquired upon illumination of the scene with the respective illuminant or LED of the illuminant may include luminescence only or luminescence and reflectance. Typically, acquisition of luminescence only takes longer than acquisition of luminescence and reflectance because the reflectance returned from the scene is larger in magnitude than the luminescence returned from the scene. To prevent saturating the color sensitive sensor upon acquisition of reflectance and luminescence, shorter acquisition durations need to be used than for luminescence only. The sensitivity of each color sensitive sensor for the respective illuminant or LED can be determined by determining the minimum illumination duration required for each illuminant or each LED of the illuminant to give an image with a sufficient image exposure. “Sufficient image exposure” refers to an image which is not overexposed (i.e. the image appears too light or too white for an RGB camera) or underexposed (i.e. the image appears too dark or too black for an RGB camera). Methods to automatically determine the proper illumination duration for each illuminant of the light source for RGB color cameras are, for example, described in US 2004/0085475 A1. Methods to automatically determine the proper illumination duration for each illuminant of the light source for multi- or hyperspectral cameras are, for example, described in A. Sohaib et. al., “Automatic exposure control for multispectral cameras,” 2013 IEEE International Conference on Image Processing, 2013, pages 2043 to 2047, doi: 10.1109/ICIP.2013.6738421). The illumination duration may be selected such that saturation of the sensor is avoided to ensure that the delta-calculation described below yields correct results. In case the sensor is saturated, the response curve of the sensor needs to be used to calculate the corresponding intensity increase prior to performing delta-calculation. In case the sensor is not saturated, i.e. 1 unit light increase equals a proportional sensor response across the light intensity range, delta-calculation can be performed without any further processing of the acquired data. Each illuminant of the light source may be associated with one or more defined illumination duration which may be identical or may vary, i.e. a different illumination duration may be used for the first illumination time point than for the second defined illumination time point determined for the respective illuminant as described below. Use of different illumination durations for a single illuminant may be preferred if different sensors are used to acquire the luminescence only and the luminescence and reflectance of the object resulting from illumining the scene with the respective illuminant.

The order of steps (b) and (c) may be reversed, i.e. the flicker cycle may be determined after determination of the illumination duration of each illuminant.

In step (d), the acquisition durations for each color sensitive sensor of the sensor unit are determined based on the provided digital representations, the determined illumination conditions and optionally the determined flicker cycle. This may be performed according to different methods.

In one example, determining the acquisition durations for each sensor of the sensor unit includes determining whole number integer multiples based on the data determined in step (b) and matching the determined whole number integer multiples to the illumination durations determined in step (c). The whole number integer multiples may be determined by using fixed whole number integer multiples based on the flicker cycle determined in step (b). Suitable fixed whole number integer multiples include 1/60 of a second and/or 2/60 of a second and/or 3/60 of a second and/or 4/60 of a second for a determined flicker cycle of 120 Hz. For a determined flicker cycle of 100 Hz, fixed whole number integer multiples of 1/50 of a second and/or 2/50 of a second and/or 3/50 of a second and/or 4/50 are preferably used. However, it is also possible to use other whole number numerators than 1, 2, 3 and 4 to adapt the acquisition duration of the sensor(s) to the specific circumstances of the scene. The fixed whole number integer multiples may be stored in on a data storage medium, such as a database, and may be retrieved by the processing unit based on the flicker cycle determined in step (a). As outlined below, use of a whole number integer multiple of the flicker cycle allows to perform accurate delta-calculations because the ambient light contribution contained in the data used for delta-calculation (i.e. data acquired of the scene without illumination from the light source and data acquired from the scene upon illumination of the scene with at least one illuminant of the light source) remains constant, thus resulting in differential data only containing the luminescence or luminescence and reflectance due to the illumination of the scene with the respective illuminants of the light source.

Matching the determined whole number integer multiples to the illumination durations determined in step (c) may include comparing the determined illumination durations with the determined whole number integer multiples and associating the determined whole number integer multiples with the respective illumination duration. Associating the determined whole number integer multiples with the respective illumination duration may include associating the respective illumination duration with the identical whole number integer multiples or associating the respective illumination duration with the next higher whole number integer multiples in case the respective illumination duration is lying between two whole number integer multiples. For example, if an illumination duration for illuminant 1 of the light source was determined in step (c) to be lower than 1/60 of a second for color sensitive sensor 1, an acquisition period of 1/60 of a second is used for color sensitive sensor 1. Similarly, if the determined illumination duration is >1/60 but <=2/60 of a second, then the acquisition duration is set to 2/60 of a second, and so forth.

In another example, determining the acquisition durations for each color sensitive senor includes using acquisition durations which are identical to the illumination durations determined in step (c). This may be preferred if the acquisition time points for each sensor are determined using phase-locking as described later on.

In step (e) the illumination time points for each illuminant and/or for each LED of the illuminant (i.e. the time points when each illuminant/LED is switched on) and the acquisition time points for each sensor (i.e. the time points when each sensor is switched on) of the sensor unit are determined based on the data determined in step (d) and optionally in step (b). In one example, the illumination time point differs for each illuminant and/or each LED of each illuminant such that only one illuminant and/or one LED is switched on at a defined illumination time point and the scene is therefore only illuminated with exactly one specific illuminant and/or one specific LED of a specific illuminant at the defined time point(s). In another example, the at least one defined illumination time point may be identical for at least two illuminants and/or at least two LEDs of the illuminant such that the scene is illuminated by several illuminants and/or several LEDs of the illuminant at once. In case the light source comprises more than one illuminant and/or at least one illuminant comprises more than one LED, the illuminants and/or LEDs may be switched on and off in a defined order, for example sequentially by increasing wavelength, at defined time point(s) by the control unit. Each illuminant and/or each LED of each illuminant is preferably switched on and off at least once during a cycle (a cycle includes switching on and off all illuminants of the light source and all LEDs of the illuminant). In case the sensor unit comprises at least two color sensitive sensors, it may be preferred to switch on and off each illuminant and/or each LED of each illuminant several times during a cycle, for example at least twice. This allows to acquire data of the scene with each color sensitive sensor of the sensor unit when the scene is illuminated by a specific illuminant and/or a specific LED of a specific illuminant as described below.

In case the determined flicker cycle is already used to determine the acquisition duration (i.e. to use whole number integer multiples for the acquisition durations as previously described), the time points are determined using the data determined in step (d). This may include synchronizing the illumination and acquisition durations determined in steps (c) and (d) such that they at least partially overlap, in particularly only partially overlap. Only partial overlap allows to acquire background data (i.e. data of the scene without illumination of the scene with the light source) required for performing delta-calculation. The illumination time point for switching on each respective illuminant and/or each LED of each illuminant may be selected such that it is delayed, for example by 0.4 to 0.6 ms, with respect to the acquisition time point for switching on the respective sensor of the sensor device. This may prevent issues with the sensors' initial readings upon illumination of the scene with the light source. However, it may also be possible to switch on the color sensitive sensor after the respective illuminant/LED is switched on.

In case the acquisition durations are determined by using identical durations as for the illumination conditions, the determined flicker cycle is used to determine the acquisition time points. This may include using phase-locking as described later on such that each color sensitive sensor is always switched on and preferably off at the same part of the flicker cycle. This allows to reliably acquire data (e.g. images) at the same phase of the ambient light flicker and prevents gradual drifting of the phase between the data acquisition and the flicker occurring if the data acquisition of the scene would be performed by the sensor(s) at almost the identical frequency as the flicker. The phase-locking may be performed relative to the light variation or relative to the line voltage fluctuation because the two are phase-locked relative to each other.

After determining the acquisition time points, the illumination and acquisition durations determined in steps (c) and (e) are synchronized such that they at least partially overlap, in particularly only partially overlap. The partial overlap may be obtained by delaying the illumination time point(s) for switching on each respective illuminant and/or each LED of the respective illuminant, for example by 0.4 to 0.6 ms, with respect to the acquisition time point for switching on the respective sensor of the sensor device. Use of phase-locking, as described later on, allows to perform accurate delta-calculations because the ambient light contribution contained in the data used for delta-calculation (i.e. data acquired of the scene without illumination from the light source and data acquired from the scene upon illumination of the scene with at least one illuminant of the light source) remains constant, thus resulting in differential data only containing the luminescence or luminescence and reflectance due to the illumination of the scene with the respective illuminants of the light source.

In optional step (f), the data determined in step (e) is provided via a communication interface. The data determined in step (e) includes the synchronization of the light source and the illuminant, i.e. data on the acquisition and illumination durations as well as data on the illumination and acquisition time points for each illuminant and each sensor. The data may be provided to a further processing and/or the control unit described later on and/or the display device described later on.

The previously described method can be used for synchronizing the illuminants of the light source and the sensors of the sensor unit. The determined synchronization can be provided to the control unit described later on for controlling the light source and sensors according to the determined synchronization. The processing unit may be configured to adjust the determined synchronization based on the acquired data as described below, for example by determining the flicker cycle and/or sensitivity of each sensors during regular intervals and adjusting the durations and/or time points if needed.

The inventive system may further comprise a control unit configured to control the light source and/or the sensor unit. Suitable control units include Digilent Digital Discovery controllers providing ˜1 microsecond level control or microcontrollers, such as PJRC Teensy® USB Development Boards. Microcontrollers or microprocessors refer to semiconductor chips that contain a processor as well as peripheral functions. In many cases, the working and program memory is also located partially or completely on the same chip. The control unit may either be present within the processing unit, i.e. it is part of the processing unit, or it may be a separate unit, i.e. it present separate from the processing unit.

The control unit is preferably configured to control the light source by switching on and off the at least one illuminant and/or at least one LED of the at least one illuminant at at least one defined illumination time point for a defined illumination duration. In case at least one illuminant comprises more than one LED, each LED may be switched on and off at at least one defined illumination time point for a defined illumination duration. Switching on and off the at least one illuminant and/or LED of the illuminant at at least one defined illumination time point allows to illuminate the scene with specific illuminant(s)/specific LEDs of specific illuminants. In one example, the at least one defined illumination time point differs for each illuminant and/or each LED of each illuminant such that only one illuminant/LED of is switched on at a defined illumination time point and the scene is therefore only illuminated with exactly one specific illuminant/LED at the defined time point(s). If at least one illuminant comprising more than one LED is used, the defined illumination points for all LEDs in the illuminant(s) differ from each other. Similarly, if a combination of illuminant(s) comprising LED(s) and further illuminant(s) (i.e. incandescent and/or fluorescent illuminants) is used, the defined time points of all LEDs in the LED illuminant(s) and the defined time points for the further illuminant(s) differ from each other. In another example, the at least one defined illumination time point may be identical for at least two illuminants and/or for at least two LEDs of the illuminant of the light source such that the scene is illuminated by several illuminants/LEDs at once. In case the light source comprises more than one illuminant and/or the illuminant comprises more than one LED, the illuminants/LEDs may be switched on and off in a defined order, for example sequentially by increasing wavelength, at defined time point(s) by the control unit. Each illuminant and/or each LED of each illuminant is preferably switched on and off at least once during a cycle (a cycle includes switching on and off all illuminants and all LEDs of an illuminant of the light source). In case the sensor unit comprises at least two color sensitive sensors, it may be preferred to switch on and off each illuminant and/or each LED of each illuminant several times during a cycle, for example at least twice. This allows to acquire data of the scene with each color sensitive sensor of the sensor unit when the scene is illuminated by a specific illuminant and/or by a specific LED of the illuminant. In case each illuminant of and/or each LED of each illuminant is switched on at at least two defined illumination time points, the defined illumination duration associated with each defined illumination time point may be identical or may be different, i.e. a different illumination duration may be used for the first defined illumination time point than for the second defined illumination time point. The defined illumination duration(s) may vary for each illuminant and/or each LED of each illuminant and generally depend(s) on the wavelength of the respective illuminant and/or the respective LED of the illuminant and the sensitivity of the respective color sensitive sensor to the illuminant and/or the LED of respective illuminant. Suitable illumination time point(s) and illumination duration(s) for each illuminant and/or each LED of the illuminant can be determined experimentally. Determination of the illumination duration may be performed as previously described by determining the minimum illumination duration required for each illuminant or each LED of each illuminant to give an image with a sufficient image exposure as previously described. Determination of suitable illumination time points may be accomplished by determining suitable acquisition time points or acquisition durations for each color sensitive sensor and synchronizing all determined time points and durations as described below.

Using at least two defined illumination time points for switching on each illuminant and/or each LED of each illuminant may be preferred if at least two color sensitive sensors are present in the sensor unit because this allow to configure the defined illumination duration for each defined illumination time point to accommodate the fact that measurement of luminescence only using the first color sensitive sensor takes longer than the measurement of the reflectance+luminescence using the second color sensitive sensor. This is due to the fact that the measurement of reflectance+luminescence contains the reflected light from the illuminant of the light source, and reflection is typically much stronger than luminescence. In one example, illumination duration corresponds to the acquisition duration (i.e. time between switch on and switch off) used for each color sensitive sensor. In another example, the illumination duration is less than the acquisition duration used for each color sensitive sensor, i.e. the respective illuminant and/or the respective LED of the respective illuminant is switched on with a delay, for example ˜0.5 ms, with respect to the switch-on of the respective color-sensitive sensor. The latter may be preferred to avoid possible issues with the sensors' initial readings during the critically important illumination period. The control unit may further be configured to control the sensor unit by switching on and off the at least one color sensitive sensor at defined acquisition time points and/or under defined lighting conditions for a defined acquisition duration. The defined lighting conditions may include ambient lightning or ambient lightning in combination with illumination from the light source.

As previously described, flickering of the light sources in the scene may be a problem if the delta-calculation is performed to realize object recognition under ambient lightning conditions and the acquisition duration of each color sensitive sensor is very short compared with the flicker period because the ambient light contribution can vary by 100% depending on when in the flicker cycle the acquisition begins. When the acquisition duration is much larger than the flicker cycle time, small changes in the phase (i.e. the acquisition duration during a flicker cycle) between the flicker and the acquisition number of flicker cycles recorded will lead to small differences between the acquired data because the difference in brightness due to the starting phase is divided by the total number of cycles recorded. However, as the acquisition duration approaches the flicker cycle time, the total number of flicker cycles recorded decreases while the difference in flicker cycle phase recorded remains the same, so the difference increases. Thus, the result of the delta-calculation is only accurate if the same ambient lightning contribution is present during the capture of the images which are to be subtracted, i.e. the accurate determination of the contribution of each illuminant to the measured luminescence and reflectance is highly dependent on the acquisition duration of each color sensitive sensor as well as its timing with respect to the flicker cycle of the light sources being present in the scene. It is therefore preferred, if the defined acquisition time points and/or the defined acquisition duration are dependent on the flicker cycle of all light sources being present in the scene to eliminate variation in the contribution from the ambient light, thus allowing an accurate determination of the contribution of each illuminant to the measured luminescence and reflectance and therefore increasing the accuracy of the object detection under ambient lightning conditions (e.g. conditions applicable to object recognition under rea-life situations).

The defined acquisition time points and/or the defined acquisition durations may be set according to different methods as previously described. In one example, the defined acquisition time points are set via phase-locking such that each color sensitive sensor is always switched on and off at the same part of the flicker cycle (i.e. the same phase). This allows to reliably acquire data (e.g. images) at the same phase of the ambient light flicker and prevents gradual drifting of the phase between the data acquisition and the flicker occurring if the data acquisition of the scene would be performed by the sensor(s) at almost the identical frequency as the flicker. The phase-locking may be performed relative to the light variation or relative to the line voltage fluctuation because the two are phase-locked relative to each other. The flicker cycle for most common lightning conditions is either known (for example, the flicker is at a 120 Hz rate in the US and at a 100 Hz rate in Europe) or can be determined. In one example, determination of the flicker cycle can be performed by the processing unit or a further processing unit as described in US 2015/0163392 A1, US 2002/0097328 A1 and D. Poplin, “An automatic flicker detection method for embedded camera systems,” IEEE Transactions on Consumer Electronics, vol. 52, no. 2, pages 308 to 311, May 2006, doi: 10.1109/TCE.2006.1649642. In another example, the flicker cycle can be determined with commercially available flicker detection systems, such as, for example, AMS TCS3408 Color Sensor from ams AG. Depending on this determination, the processing unit and/or the control unit may be programmed to set or adjust the phase-locking to the determined flicker cycle. The defined acquisition duration for each color sensitive sensor is not fixed to specific durations but may be adapted to the illumination duration necessary to acquire sufficient data with the respective sensor. Suitable defined acquisition durations include durations being equal to one flicker cycle (for example 1/120 of a second or 1/100 of a second dependent upon flicker rate), being longer than one flicker cycle to capture multiple flicker cycles, for example by using whole number integer multiples of the flicker cycle (for example 1/60 of a second or 1/50 of a second, etc.), or being shorter than one flicker cycle (for example 1/240 or 1/200 of a second dependent upon the flicker rate). Typically, the acquisition duration of the sensor(s) is less than the flicker cycle in order to speed up data acquisition. Use of phase-locking for determining the defined acquisition time points for switching on each color sensitive sensor is preferably used to shorten object recognition times because a shorter acquisition duration for each sensor (i.e. the defined acquisition duration) than the flicker cycle can be used. If phase-locking is used, the illuminants also need to be synced to the phase-locking to ensure that the scene is illuminated with at least one illuminant of the light source during the acquisition duration of each color sensitive sensor of the sensor unit. In one example, the illumination duration is shorter than the acquisition duration of the respective sensor to allow for acquisition of the ambient lightning data (i.e. data where no illuminant of the light source is switched on) and to avoid issues with the sensors' initial readings as previously described. In another example, the illumination duration is equal to the acquisition duration of each sensor. In this case, the background data (i.e. data acquired under ambient lightning conditions only without the light source being switched on) is acquired after a complete illumination cycle (i.e. after each illuminant of the light source including each LED of each illuminant has been switched on and off at least once). In yet another example, the illumination duration is longer than the acquisition duration for each sensor. This may be preferred if longer illumination durations are required to reach the equilibrium output of the respective illuminant.

In another example, the defined acquisition duration is set to a whole number integer multiple of the flicker cycle, i.e. the defined acquisition duration is fixed to at least one specific value. It may be preferred to use various defined acquisition durations to account for the different illumination durations necessary to obtain sufficient exposure for each sensor under illumination from each illuminant and/or from each LED of each illuminant. When the acquisition duration of each sensor is equal to the flicker cycle, the amount of flicker light collected is always the same regardless of the phase between the flicker and the beginning of the acquisition duration. Following the same principle, any whole number integer multiple of the flicker cycle will also result in an identical flicker contribution regardless of the phase of the acquisition duration. Thus, the acquisition duration for each color sensitive sensor is preferably set to a defined whole number integer multiple of the flicker period. In one example, defined acquisition durations for each color sensitive sensor of 1/60 of a second and/or 2/60 of a second and/or 3/60 of a second and/or 4/60 of a second are used. This is preferred for light sources having a flicker cycle of 120 Hz (i.e. light sources using a 60 V utility frequency). In another example, defined acquisition durations for each color sensitive sensor of 1/50 of a second and/or 2/50 of a second and/or 3/50 of a second and/or 4/50 of a second are used. This is preferred for light sources having a flicker cycle of 100 Hz (i.e. light sources using a 50 V utility frequency). It is also possible to use other whole number numerators than 1, 2, 3 and 4 to adapt the acquisition duration of the sensor(s) to the specific circumstances of the scene. Use of defined acquisition durations being a whole number integer multiple of the flicker cycle for each color sensitive sensor of the sensor unit is preferably used if the acquisition duration is similar or longer than the flicker cycle. Moreover, the use of defined acquisition durations being a whole number integer multiple of the flicker cycle provides better mitigation of PWM (pulse-width modulation) LED lighting because more flicker cycles are captured such that small time shifts of the acquisition duration relative to the duration of each flicker cycle (i.e. the acquisition duration being off a fraction compared to the flicker cycle) are less impactful on the result of the delta-calculation. If a defined acquisition duration for each color sensitive sensor is used, the defined illumination duration of each illuminant and/or each LED of each illuminant needs to be synchronized to the defined acquisition durations of the sensors to ensure that the scene is illuminated with at least one illuminant and/or at least one LED of at least one illuminant during the acquisition duration of each color sensitive sensor of the sensor unit. The illumination duration may be shorter than the acquisition duration of the sensor, may be equal to the acquisition duration of each sensor or may be longer than the acquisition duration of each sensor as previously described.

In one example, the control unit may be configured to switch on the color sensitive sensors at defined acquisition time points (i.e. using phase-lock) instead of setting defined acquisition durations (i.e. using whole number integer multiples of a flicker cycle) to speed up data acquisition. For this purpose, the switching on of each color sensitive sensor is locked to the phase of the flicker cycle and the acquisition duration may be set to the flicker cycle (i.e. to 1/120 of a second or 1/100 of a second), whole number integer multiples of the flicker cycle or shorter than the flicker cycle. The defined illumination time point(s) and illumination duration(s) for each illuminant and/or each LED of each illuminant are then determined such that the illumination and acquisition durations overlap at least partially as described below. In another example, the control unit may be configured to switch on the color sensitive sensors at defined acquisition durations (i.e. using whole number integer multiples of a flicker cycle) instead of setting defined time points (i.e. using phase-lock) to mitigate for PWM LED lightning being present in the scene. The illumination period necessary for each color sensitive sensor to acquire sufficient data is then determined as previously described. The defined illumination and acquisition time points are then determined such that the illumination and acquisition durations overlap at least partially as described below.

In an aspect, the control unit is configured to synchronize the switching on and off of the illuminant(s) and/or the LEDs of the illuminant(s) and the color sensitive sensor(s) of the sensor unit such the defined acquisition durations of each color sensitive sensor and the defined illumination durations of each illuminant and/or each LED of each illuminant, overlap at least partially. To eliminate different contributions of flicker to the differential data obtained after delta-calculation, the partial overlap of the defined illumination durations of each illuminant and/or each LED of each illuminant and the defined acquisition durations of each color sensitive sensor is preferably based on the flicker cycle of all light sources present in the scene. This may be accomplished by configuring the control device to switch on each color sensitive sensor via phase-locking at the same part of the flicker cycle or to switch on and off (i.e. use defined acquisition duration(s)) each color sensitive sensor of the sensor unit using a whole number integer multiple of the flicker cycle.

In one example, the defined illumination duration for each illuminant and/or each LED of each illuminant and the defined acquisition duration for each color sensitive sensor are set to fixed values, which may either be stored on an internal memory of the control unit and may be retrieved prior to the synchronization. The fixed acquisition durations or fixed acquisition time points may be obtained by determining the flicker cycle as previously described and using the determined flicker cycle to determine the acquisition time points (i.e. setting the acquisition time points via phase-locking) or to determine the acquisition duration (i.e. using whole number integer multiples of the determined flicker cycle). Determining the acquisition duration may include considering the saturation point of each sensor to ensure that the delta-calculation yields correct results. In case the sensor is saturated, the response curve of the sensor needs to be used to calculate the corresponding intensity increase prior to performing delta-calculation. In case the sensor is not saturated, i.e. 1 unit light increase equals a proportional sensor response across the light intensity range, delta-calculation can be performed without any further processing of the acquired data. It may therefore be preferred to choose acquisition durations such that saturating each sensor is avoided. This may be performed, for example, by using a lower whole number integer multiple to capture less cycles of ambient light flicker.

In another example, the set durations can be dynamically adjusted based on real time evaluation of the sensor readings to ensure that different levels of ambient lighting or different distances from the system to the object are considered, thus increasing the accuracy of object recognition. This may be performed, for example, by determining the flicker cycle and/or the sufficient exposure of each sensor and adjusting the acquisition duration and/or the illumination duration and/or the defined time points for each sensor and/or each illuminant accordingly.

The illumination duration for each illuminant and/or each LED of each illuminant is preferably set to achieve a reasonable measurement within the exposure time of the respective sensor, while leaving room for acquiring data of the ambient lighting (i.e. data of the scene without the light source being switched on). As previously described, a shorter illumination duration for the color sensitive sensor capturing reflectance+luminescence is needed as compared to the sensitive sensor capturing luminescence only, as the measurement for the reflectance+luminescence contains the reflected light from the illuminant of the light source, and reflection is typically much stronger than luminescence. If phase-locking is used, the acquisition duration and the illumination duration can be adjusted to achieve reasonable measurement. If the defined acquisition durations are set to whole number integer multiples of the flicker cycle, a defined acquisition duration of 1/60 or 1/50 of a second is used in case the illumination duration is less than 1/60 of a second. Similarly, if it is >1/60 of a second but <=2/60 of a second, then the 2/60 of a second acquisition duration is used, and so forth.

To avoid issues with the sensors' initial readings during the critically important illumination period, it may be preferred if the overlap of the defined illumination durations and the defined acquisition durations only partially. This also allows to acquire data under ambient lightning conditions (i.e. without the light source being switched on) after or prior to switching on each illuminant and/or each LED of each illuminant. The at least partial overlap can be achieved by setting the defined time points of switching on the respective illuminant or respective LED and the respective color sensitive sensor such that either the illuminant/LED or the sensor is switched on with a delay. In one example, the illumination “on” period of the respective illuminant or the respective LED is delayed for a small period of time (such as, for example, ˜0.5 ms) after the defined acquisition duration of the respective sensor has started. In this case, total capture time for the inventive system can be shortened by overlapping the “off” illumination periods for each sensor's acquisition durations.

In one example, the control unit is configured to switch on the illuminants or the LEDs of the illuminant according to their respective wavelength (i.e. from the shortest to the longest or vice versa) and to switch on each color sensitive sensor of the sensor device sequentially. In another example, the control unit is configured to switch on the illuminants or the LEDs of the illuminant in an arbitrary order, i.e. not sorted according to their wavelength, and to switch on the corresponding color sensitive sensor associated with the respective illuminant or the respective LED of the respective illuminant. In case the light source comprises multiple illuminants with the same color or illuminants comprising multiple LEDs with the same color (for example two blue, two green and two red illuminants or LEDs), the control unit may be configured to cycle through each color twice, i.e. by switching on blue1, green1, red1, blue2, green2, red2, to achieve a more uniform white balance over time.

In one example, the control unit is configured to switch on each color sensitive sensor without switching on any illuminant and/or any LED of any illuminant after each illuminant and/or each LED of each illuminant has been switched on (i.e. after one cycle is complete) to acquire the background data (i.e. data without the light source of the inventive system being switched on) required for delta-calculation. Measurement of the background data is performed using the same defined time points and defined duration(s) for each color sensitive sensor as used during the cycling through the illuminants/LEDs of the illuminants (i.e. if defined durations of 1/60, 2/60, 3/60 and 4/60 of a second were used during data acquisition with the illuminants/LEDs being switched on, the same durations are used for acquisition of the background data). In another example, the background measurements are made at different intervals, such as for every sensor capture or between multiple cycles, depending on the dynamism of the scene, desired level of accuracy, and desired acquisition time per cycle. The acquired background data is subtracted from the illuminator/LED “on” acquired data using the corresponding acquisition duration to yield the differential image as previously described. This allows to account for common sources of indoor lighting flicker and thus allows to use the inventive system under real-life conditions with a high accuracy of object recognition.

The control unit may be configured to add extra illumination to the scene by switching on an illuminant/LED of an illuminant at a time when all color sensitive sensors of the sensor unit are switched off to achieve better color balance between the illuminants and/or the LEDs of the illuminant and to make the light of the light source appear more “white”.

In an aspect, the system further comprises a display unit configured to display the determined object(s) and optionally further data. The display unit may be a display device having a screen on which the determined objects and optionally further data may be displayed to the user. Suitable display units include stationary display devices (e.g. personal computers, television screen, screens of smart home systems being installed within a wall/on a wall) or mobile display devices (e.g. smartphones, tablets, laptops). The display device can be connected with the processing unit via a communication interface which may be wired or wireless. The further data may include data acquired on the object specific reflectance and/or luminescence properties, determined further object specific reflectance and/or luminescence properties, data from the control unit, such as switching cycles of illuminant(s) and light sensitive sensor(s), used matching algorithms, results obtained from the matching process and any combination thereof.

The light source and the sensor unit may have a specific arrangement with respect to each other and/or with respect to the scene. It may be preferred if the light source is arranged in an angle of 7° with respect to the sensor unit and/or if the light source is arranged in an angle of 20° with respect to the vertical plane of the scene and/or if the sensor unit is arranged in an angle of 33° with respect to the specular angle of the scene. The specific arrangement of light source and sensor unit with respect to each other and/or light source/sensor unit with respect to the scene results in reduction of specularity (i.e. white light reflection) and therefore mitigates the loss of color information associated with the presence of specularity.

### Embodiments of the Inventive Computer-Implemented Method:

In an aspect of the inventive method, steps (i) and (ii) are controlled by the computer processor. This may include switching on the illuminant(s) and/or the LED(s) of the illuminant(s) sequentially and synchronizing the switching of the color sensitive sensor(s) present in the sensor unit to the switching of the illuminant(s) and/or the LEDs of the illuminant(s) such that each color sensitive sensor acquires data when each illuminant and/or each LED of each illuminant is switched on. Switching on the illuminants of the light source or the LEDs present in the LED illuminant sequentially means that only exactly one illuminant and/or exactly one LED of the illuminant is switched on at a time while the remaining illuminants/LEDs are switched off. By cycling through all illuminants (i.e. by switching on and off exactly one illuminant/LED at a time), the scene can be illuminated with all illuminants of the light source and the data acquired from illumination of the scene with the respective illuminant can be used to determine the object as previously described. In case at least two color sensitive sensors are present, each illuminant/LED is preferably switched on and off twice as previously described to allow data acquisition with the respective sensor while the other sensor is switched off. Due to the presence of the camera filters, each sensor either acquires the luminescence only or the reflectance+luminescence as previously described. Synchronization of the illuminants/LEDs and the color sensitive sensors of the sensor unit may be performed using the method described in relation with the processing unit and is outlined briefly hereinafter.

To perform the inventive method under ambient lightning conditions, the ambient lightning present in scene (i.e. the lightning conditions present without switching on the light source of the inventive method, also called background data hereinafter) must be subtracted from the lightning conditions present in the scene when the light source of the inventive method is switched on to determine the luminescence and optionally reflectance under each illumination condition. Due to the flicker of light sources present in the scene, the ambient light contribution may vary if the background data and the data acquired during the respective illuminator being switched on are taken at different phases of the flicker cycle as previously described.

To reliably determine the luminescence and reflectance of the objects under the respective illumination conditions of the light source (i.e. to eliminate variation in the contribution from the ambient light), synchronizing the switching of the color sensitive sensor(s) present in the sensor unit to the switching of the illuminant(s) present in the light source preferably includes synchronizing the switching based on the flicker cycle of all light sources present in the scene.

In on example, the switching is synchronized based on the flicker cycle of all light sources present in the scene by switching on and off each color sensitive sensor at defined acquisition time points via phase locking such that each color sensitive sensor is always switched on at the same part of the flicker cycle and synchronizing the switching on and off of each illuminant and/or each LED of each illuminant to the defined acquisition time points of each sensor device. The phase-locking may be performed relative to the light variation or relative to the line voltage fluctuation as previously described. The illumination duration of each illuminant and/or LED of each illuminant and the acquisition duration of each color sensitive sensor are set to achieve a reasonable measurement within the range of the sensor, while leaving room for effect of the additional ambient lighting as previously described. If two color sensitive sensors are used, the illumination and acquisition duration necessary for capturing the luminescence+reflectance is shorter than the illumination and acquisition duration necessary for capturing luminescence only because the reflectance is much stronger than the luminescence. In this case, two different illumination and acquisition durations are used each time the respective illuminant/LED is switched on (i.e. the first illumination duration of the respective illuminant/LED and acquisition duration period of color sensitive sensor 1 differs from the second illumination duration of the respective illuminant/LED and acquisition duration of color sensitive sensor 2). Suitable illumination and acquisition durations include durations being equal to one flicker cycle (for example 1/120 of a second or 1/100 of a second) being longer than one flicker cycle to capture multiple flicker cycles, for example by using whole number integer multiples of the flicker cycle (for example 1/60 of a second or 1/50 of a second, etc.) or being faster than one flicker cycle as previously described.

In another example, the switching is synchronized based on the flicker cycle of all light sources present in the scene by switching on and off each color sensitive sensor at defined acquisition durations such that each color sensitive sensor is switched on for a whole number integer multiple of the flicker cycle and synchronizing the switching on and off of each illuminant and/or each LED of each illuminant to the defined acquisition duration of each sensor device. It may be preferably to use various pre-defined values to account for the different acquisition durations necessary to acquire sufficient data under illumination from each illuminant of the light source as previously described. In one example, pre-defined durations for each color sensitive sensor of 1/60 of a second and/or 2/60 of a second and/or 3/60 of a second and/or 4/60 of a second are used. This is preferred for light sources having a flicker cycle of 120 Hz (i.e. light sources using a 60 V utility frequency). In another example, pre-defined durations for each color sensitive sensor of 1/50 of a second and/or 2/50 of a second and/or 3/50 of a second and/or 4/50 of a second are used. This is preferred for light sources having a flicker cycle of 100 Hz (i.e. light sources using a 50 V utility frequency).

The defined acquisition time point and/or acquisition duration of each color sensitive sensor and the defined illumination time point(s) and/or illumination duration(s) of each illuminant and/or each LED of each illuminant overlap at least partially. At least partial overlap, in particular of the defined acquisition and illumination durations, ensures that data is acquired with each sensor when each illuminant of the light source is switched on. To avoid issues with the sensors' initial readings during the critically important illumination period, it may be preferred if the overlap of the defined acquisition and illumination durations is only partial. This also allows to acquire background data under ambient lightning conditions (i.e. without the light source being switched on) after or prior to switching on each illuminant of the light source. The at least partial overlap can be achieved by setting the defined illumination time points of the respective illuminant and the acquisition time points of the respective color sensitive sensor such that either the illuminant or the sensor is switched on with a delay. In one example, the illumination “on” period of a respective illuminant is delayed for a small period of time (such as, for example, ˜0.5 ms) after the defined acquisition duration of the sensor has started. In this case, total capture time for the inventive system can be shortened by overlapping the “off” illumination periods for each sensor's acquisition duration.

In an aspect, steps (i), (ii), (iii) and (v) are performed with the same computer processor. This may be preferred if the computing power of the processor is high enough to perform control of the light source and sensor unit, optionally process the acquired sensor data and determine the object(s) in the scene based on the acquired or processed data and digital representations of pre-defined objects within a reasonable time. The reasonable time depends on the application and may range from sub-seconds to minutes.

In an alternative aspect, steps (i) and (ii) are performed with a different computer processor than steps (iii) and (v). The different computer processor is configured separate from the computer processor performing steps (i) and (ii) and may be located, for example, on a further stationary computing device or at a server, such that steps (iii) and (v) of the inventive method are performed in a cloud computing environment. In this case, the computer processor performing steps (i) and (ii) functions as client device and is connected to the server via a network, such as the Internet. Preferably, the server may be an HTTP server and is accessed via conventional Internet web-based technology. The internet-based system is in particular useful, if the object recognition method is provided to customers because it does not require to install computer processors having large computing powers in the object recognition system used in the respective location but allows to shift the tasks requiring high computing power (i.e. determining the object from the acquired data) to a separate computing device.

In an aspect, the step of determining further object specific reflectance and/or luminescence properties from data acquired on the object specific reflectance and/or luminescence properties includes generating differential data, determining the regions of luminescence in the generated differential data and transforming the RGB values of the differential data into rg chromacity values or determining the luminescence spectral pattern and/or the reflective spectral pattern for the determined regions of luminescence as described in with respect to the inventive system. Thus, optional step (iii) includes processing the acquired data. This may be preferred to increase accuracy of the object recognition, especially under ambient lightning conditions being present in real-world scenes.

The object(s) based on the acquired or processed data may be determined by determining the best matching reflectance and/or luminescence properties and obtaining object(s) assigned to the best matching reflectance and/or luminescence properties as previously described. This may include applying any number of matching algorithms on the data acquired on the object specific reflectance and/or luminescence properties and/or the optionally determined further reflectance and/or luminescence properties and the provided digital representations of pre-defined objects. Suitable matching algorithms are, for example, nearest neighbors, nearest neighbors with neighborhood component analysis, neural network algorithms or a combination thereof. The objects) assigned to the best matching reflectance and/or luminescence properties may be obtained by retrieving the object(s) associated with the best matching historical reflectance and/or luminescence properties from the provided digital representations of pre-defined objects or by searching a database for said object(s) based on the determined best matching reflectance and/or luminescence properties.

The determined objects may be provided to a display device previously described and may be displayed on the screen of the display device. The screen of the display device may comprise a GUI which may also allow the user to interact with the display device. Displaying the object(s) on the screen of the display device may further comprise displaying further data and/or recommendation. Further data may include further meta-data associated with the objects, such as, for example, the price, related objects, object manufacturer, date of manufacture, location of manufacture, expiration date, etc. or a combination thereof. Suitable recommendations may include order recommendations, stock information, etc.. The further data and recommendations may either be stored in the provided digital representations or may be retrieved from a database based on the recognized objects. The displayed data may be highlighted or grouped to increase user comfort.

The method may further include the step of determining and optionally performing a pre-defined action associated with the detected object. The pre-defined action may either be determined with the processor by retrieving the respective action associated with the detected object(s) from a data storage medium, such as a database or internal storage. Pre-defined actions may include ordering of new items, updating of stock information, prompting the user to select the object in case of multiple determined best matching objects etc.. The determined action may be performed automatically after determination, i.e. without user interaction, or may be performed after user interaction, for example by clicking on a respective icon displayed on the GUI. The processor may also control the performing of the predefined action, for example by following the order process and may provide status information to the user. The information entered by the user may be stored in the digital representation of the pre-defined objects and may be used to determine the object at a later point in time.

Further embodiments or aspects are set forth in the following numbered clauses:

1. A system for object recognition, said system comprising:
a light source configured to illuminate a scene in which at least one object having object specific reflectance and/or luminescence properties is present, wherein the light source comprises at least one illuminant;
a sensor unit for acquiring data on object specific reflectance and/or luminescence properties upon illumination of the scene by the light source for each object having object specific reflectance and/or luminescence properties and being present in the scene, wherein the sensor unit includes at least one color sensitive sensor and at least one camera filter selectively blocking the reflected light and allowing passage of reflectance and/or luminescence originating from illuminating the scene with the light source into the at least one color sensitive sensor, the at least one camera filter being positioned optically intermediate the scene and the color sensitive sensor(s);
a data storage medium comprising a plurality of digital representations of pre-defined objects;
and a processing unit in communication with the sensor unit and the light source, the processing unit programmed to:
   optionally determine further object specific luminescence properties from the acquired data on object specific reflectance and/or luminescence properties, and
   determine the object(s) based on
      the data acquired on object specific reflectance and/or luminescence properties and/or the determined further object specific reflectance and/or luminescence properties and
      the digital representations of pre-defined objects.

2. The system according to clause 1, wherein the object having object specific luminescence and reflectance properties comprises at least one luminescence material, each luminescence material having a predefined luminescence property.

3. The system according to clause 2, wherein the luminescence material is used as an identification tag.

4. The system according to any of the preceding clauses, wherein the light source comprises at least 2 different illuminants and is configured to illuminate the scene by switching between the illuminants of the light source.

5. The system according to clause 4, wherein the light source comprises 2 to 20 different illuminants, more preferably 3 to 12 different illuminants, in particular 4 to 10 different illuminants.

6. The system according to any of the preceding clauses, wherein the at least one illuminant comprises at least one LED, in particular at least one narrowband LED, or wherein all illuminants comprises at least one LED, in particular at least one are narrowband LED.

7. The system according to any of the preceding clauses, wherein each illuminant of the light source, preferably each LED of the illuminant, has a full-width-half-max (FWHM) of 5 to 60 nm, preferably of 3 to 40 nm, more preferably of 4 to 30 nm, even more preferably of 5 to 20 nm, very preferably of 8 to 20 nm.

8. The system according to clause 6, wherein the FWHM is achieved by using an illuminant bandpass filter positioned directly in front of each illuminant or by using illuminants each having the FWHM.

9. The system according to any of the preceding clauses, wherein the at least one illuminant, preferably all illuminants has/have a peak center wavelength in the range of 385 to 700 nm.

10. The system according to any of the preceding clauses, wherein the light source further includes diffuser and/or focusing optics.

11. The system according to clause 10, wherein the light source comprises separate diffuser and/or focusing optics for each illuminant of the light source.

12. The system according to clause 11, wherein the focusing optics comprises an individual frosted glass.

13. The system according to clause 10, wherein the light source comprises a single diffuser and/or focusing optic for all illuminants of the light source.

14. The system according to any of the preceding clauses, wherein the data acquired on object specific reflectance and/or luminescence properties comprises or consists of RGB values, wavelength dependent radiation intensities or a combination thereof.

15. The system according to any of the preceding clauses, wherein the at least one color sensitive sensor is selected from RGB color cameras, multispectral cameras or hyperspectral cameras, in particular from RGB color cameras.

16. The system according to any of the preceding clauses, wherein the sensor unit includes two color sensitive sensors selected from RGB color cameras, multispectral cameras, hyperspectral cameras or any combination thereof, in particular from two RGB color cameras.

17. The system according to any of the preceding clauses, wherein each camera filter of the sensor unit is matched to spectral light emitted by the illuminant(s) of the light source.

18. The system according to any of the preceding clauses, wherein each color sensitive sensor comprises a camera filter.

19. The system according to clause 18, wherein each camera filter is a multi-bandpass filter and wherein all multi-bandpass filters are complementary to each other.

20. The system according to clause 19, wherein the multi-bandpass filter has a high out-of-band light rejection.

21. The system according to any one of clauses 1 to 17, wherein the sensor unit comprises a single camera filter for all color sensitive sensors present in the sensor unit.

22. The system according to clause 21, wherein the single camera filter is a multi-dichroic beam splitter.

23. The system according to any of the preceding clauses, wherein the sensor unit contains collection optics positioned optically intermediate the camera filter and each color sensitive sensor of the sensor unit or positioned optically intermediate the camera filter of each color sensitive sensor of the sensor unit and the scene.

24. The system according to any one of the preceding clauses, wherein the data storage medium is present within or outside of the processing unit.

25. The system according to any one of the preceding clauses, wherein the digital representation of each pre-defined object comprises pre-defined object specific reflectance and/or luminescence properties optionally associated with the object.

26. The system according to any one of the preceding clauses, wherein the processing unit is programmed to determine the further object specific reflectance and/or luminescence properties from the data acquired on object specific reflectance and/or luminescence properties by
generating differential data by subtracting data of the scene acquired by at least one color sensitive sensor under ambient lightning and data of the scene acquired by at least one color sensitive sensor under ambient lightning and illumination by the light source,
determining the regions of luminescence in the generated differential data and
transforming the RGB values of the differential data into rg chromacity values or determining the luminescence spectral pattern and/or the reflective spectral pattern for the determined regions of luminescence.

27. The system according to any one of the preceding clauses, wherein the processing unit is programmed to determine the object(s) based on the data acquired on object specific reflectance and/or luminescence properties and/or the optionally determined further object specific reflectance and/or luminescence properties and the digital representations of pre-defined objects by calculating the best matching reflectance and/or luminescence properties and obtaining the object(s) assigned to the best matching reflectance and/or luminescence properties.

28. The system according to clause 27, wherein the processing unit is programmed to determine the best matching reflectance and/or luminescence properties by applying any number of matching algorithms on the data acquired on object specific reflectance and/or luminescence properties and/or the optionally determined further object specific reflectance and/or luminescence properties and the digital representations of pre-defined objects stored on the data storage medium.

29. The system according to clause 28, wherein the matching algorithms are chosen from the group of nearest neighbors, nearest neighbors with neighborhood component analysis, neural network algorithms or a combination thereof.

30. The system according to any one of clauses 27 to 29, wherein the processing unit is programmed to obtain the object(s) assigned to the best matching reflectance and/or luminescence properties by retrieving the object(s) associated with the best matching reflectance and/or luminescence properties from the digital representations of the pre-defined objects stored on the data storage medium or by searching a database for said object(s) based on the determined best matching reflectance and/or luminescence properties.

31. The system according to clause 30, wherein the database is connected to the processing unit via a communication interface.

32. The system according to any one of the preceding clauses, further comprising a control unit configured to control the light source and/or the sensor unit.

33. The system according to clause 32, wherein the control unit is present with the processing unit or is present separate from the processing unit.

34. The system according to clause 32 or 33, wherein the control unit is configured to control the light source by switching on and off the at least one illuminant and/or at least one LED of the at least one illuminant at at least one defined illumination time point for a defined illumination duration.

35. The system according to clause 34, wherein the at least one defined illumination time point differ for each illuminant and/or each LED of each illuminant such that only one illuminant and/or LED is switched on at a defined illumination time point.

36. The system according to clause 34 or 35, wherein each illuminant and/or each LED of each illuminant is switched on at 2 defined illumination time points and wherein the defined illumination duration associated with each defined illumination time point is identical or is different.

37. The system according to any one of clauses 34 to 36, wherein the defined illumination duration is less or equal to the acquisition duration of each color sensitive sensor, in particular less to the acquisition duration of each color sensitive sensor.

38. The system according to any one of clauses 32 to 37, wherein the control unit is configured to control the sensor unit by switching on and off the at least one color sensitive sensor at defined acquisition time points and/or under defined lighting conditions for a defined acquisition duration.

39. The system according to clause 38, wherein the defined lighting conditions include ambient lightning or ambient lightning in combination with illumination from the light source.

40. The system according to clause 38 or 39, wherein the defined acquisition time points and/or the defined acquisition durations are dependent on the flicker cycle of all light sources present in the scene.

41. The system according to clause 40, wherein the defined acquisition time points are set via phase-locking such that each color sensitive sensor is always switched on at the same part of the flicker cycle.

42. The system according to clause 41, wherein the phase-locking is performed relative to the light variation or relative to the line voltage fluctuation.

43. The system according to clause 40, wherein the defined acquisition duration corresponds to a whole number integer multiple of the flicker cycle.

44. The system according to clause 43, wherein the whole number integer multiple of the flicker cycle is 1/60 of a second and/or 2/60 of a second and/or 3/60 of a second and/or 4/60 of a second or wherein the whole number integer multiple of the flicker cycle is 1/50 of a second and/or 2/50 of a second and/or 3/50 of a second and/or 4/50 of a second.

45. The system according to clause 43 or 44, wherein the defined acquisition time point of each color sensitive sensor is set such that the respective color sensitive sensor is switched on prior to the respective illuminant and/or the respective LED of the respective illuminant.

46. The system according to any one of clauses 32 to 45, wherein the control unit is configured to synchronize the switching on and off of the illuminant(s) and/or the LEDs of the illuminants and the color sensitive sensor(s) of the sensor unit such the defined acquisition duration of each color sensitive sensor and the defined illumination duration of each illuminant and/or each LED of each illuminant, overlap at least partially, in particular overlap only partially.

47. The system according to clause 46, wherein the at least partial overlap of the defined illumination durations of each illuminant and/or each LED for each illuminant and the defined acquisition durations of each color sensitive sensor is based on the flicker cycle of all light sources present in the scene.

48. The system according to any one of the preceding clauses, further comprising a display unit configured to display the determined object(s) and optionally further data.

49. The system according to clause 48, wherein further data includes data acquired on the object specific reflectance and/or luminescence properties, determined further object specific reflectance and/or luminescence properties, data from the control unit, such as switching cycles of illuminant(s) and light sensitive sensor(s), used matching algorithms, results obtained from the matching process and any combination thereof.

50. The system according to any one of the preceding clauses, wherein the light source is arranged in an angle of 7° with respect to the sensor unit and/or wherein the light source is arranged in an angle of 20° with respect to the vertical plane of the scene and/or wherein the sensor unit is arranged in an angle of 33° with respect to the specular angle of the scene.

51. A computer-implemented method for recognizing at least one object having specific luminescence properties in a scene, the method comprising:
(i) illuminating—with a light source comprising at least one illuminant—the scene in which the least one object having object specific reflectance and/or luminescence properties is present;
(ii) acquiring—with a sensor unit—data on the object specific reflectance and/or luminescence properties upon illuminating the scene with the light source for each object having object specific reflectance and/or luminescence properties and being present in the scene, wherein the sensor unit includes at least one color sensitive sensor and at least one camera filter selectively blocking the reflected light and allowing passage of reflectance and/or luminescence originating from illuminating the scene with the light source into the at least one color sensitive sensor, the at least one camera filter being positioned optically intermediate the scene and the sensor(s);
(iii) optionally determining—with a computer processor—further object specific reflectance and/or luminescence properties from the data acquired in step
(ii);
(iv) providing to the computer processor via a communication interface digital representations of pre-defined objects;
(v) determining—with the computer processor—the object(s) based on data acquired on object specific reflectance and/or luminescence properties and/or the optionally determined further object specific reflectance and/or luminescence properties and the provided digital representations of pre-defined objects, and
(vi) optionally providing via a communication interface the determined object(s).

52. The method according to clause 51, wherein steps (i) and (ii) are controlled by the computer processor.

53. The method according to clause 51, wherein controlling steps (i) and (ii) by the computer processor includes switching on the illuminant(s) and/or the LED(s) of the illuminant(s) sequentially and synchronizing the switching of the color sensitive sensor(s) present in the sensor unit to the switching of the illuminant(s) and/or the LEDs of the illuminant(s) such that each color sensitive sensor acquires data when each illuminant and/or each LED of each illuminant is switched on.

54. The method according to clause 53, wherein synchronizing the switching of the color sensitive sensor(s) present in the sensor unit to the switching of the illuminant(s) present in the light source includes synchronizing the switching based on the flicker cycle of all light sources present in the scene.

55. The method according to clause 54, wherein synchronizing the switching based on the flicker cycle of all light sources present in the scene includes switching on and off each color sensitive sensor at defined acquisition time points via phase locking such that each color sensitive sensor is always switched on at the same part of the flicker cycle and synchronizing the switching on and off of each illuminant and/or each LED of each illuminant to the defined acquisition time points of each sensor device.

56. The method according to clause 55, wherein the phase-locking is performed relative to the light variation or relative to the line voltage fluctuation.

57. The method according to clause 54, wherein synchronizing the switching based on the flicker cycle of all light sources present in the scene includes switching on and off each color sensitive sensor at defined acquisition durations such that each color sensitive sensor is switched on for a whole number integer multiple of the flicker cycle and synchronizing the switching on and off of each illuminant and/or each LED of each illuminant to the defined acquisition duration of each sensor device.

58. The method according to clause 57, wherein the whole number multiple of the flicker cycle is 1/60 of a second and/or 2/60 of a second and/or 3/60 of a second and/or 4/60 of a second.

59. The method according to any one of clauses 55 or 58, wherein the defined acquisition time point and/or acquisition duration of each color sensitive sensor and the defined illumination time point(s) and/or illumination duration(s) of each illuminant and/or each LED of each illuminant overlap at least partially, in particular overlap only partially.

60. The method according to any one of clauses 51 to 59, wherein steps (i), (ii), (iii) and (v) are performed with the same computer processor.

61. The method according to any one of clauses 51 to 60, wherein steps (i) and (ii) are performed with a different computer processor than steps (iii) and (v).

62. A non-transitory computer-readable storage medium, the computer-readable storage medium including instructions that when executed by a computer, cause the computer to perform the steps according to the method of any of clauses 51 to 61.

63. A system comprising:
a scene; and
at least identified object, wherein the object was recognized using the system according to any one of claims 1 to 50 or according to the method of any one of clauses 51 to 61.

64. Use of a system of any of clauses 1 to 50 or the method according to any one of clauses 51 to 61 for identifying objects having object specific reflectance and/or luminescence properties in a scene.

### BRIEF DESCRIPTION OF THE DRAWINGS

These and other features of the present invention are more fully set forth in the following description of exemplary embodiments of the invention. To easily identify the discussion of any particular element or act, the most significant digit or digits in a reference number refer to the figure number in which that element is first introduced. The description is presented with reference to the accompanying drawings in which:

FIG. 1a illustrates a system in accordance with an embodiment of the invention

FIG. 1b illustrates a system in accordance with a preferred first embodiment of the invention

FIG. 1c illustrates a system in accordance with a preferred second embodiment of the invention

FIG. 2 shows an example of light output narrowing due to a bandpass filter on an LED illuminant of the light source

FIG. 3 shows a transmission profile of two complementary multibandpass filters

FIG. 4 shows a preferred system geometry to avoid specularity

FIG. 5 illustrates the influence of ambient light flicker contribution for different sensor exposure times

FIG. 6 shows a flow diagram of a computer-implemented method for recognizing at least one object having object specific luminescence properties in a scene according to an embodiment of the invention

FIG. 7 shows a diagram for synchronizing the switching of two color sensitive sensors of the sensor unit and ten illuminants by switching on each sensitive sensor for a whole number multiple of the 120 Hz flicker cycle (1/60, 2/60, 3/60 and 4/60 of a second) and synchronizing the switching of each illuminant to the pre-defined time duration of each sensor for the purposes of ambient light compensation using the delta calculation with light sources that may have flicker

FIG. 8 shows a diagram illustrating the influence of increasing amounts of ambient lighting on the average channel intensity of each RGB channel before and after performing the ambient light compensation using the synchronization described in relation to FIG. 7

### DETAILED DESCRIPTION

The detailed description set forth below is intended as a description of various aspects of the subject-matter and is not intended to represent the only configurations in which the subject-matter may be practiced. The appended drawings are incorporated herein and constitute a part of the detailed description. The detailed description includes specific details for the purpose of providing a thorough understanding of the subject-matter. However, it will be apparent to those skilled in the art that the subject-matter may be practiced without these specific details.

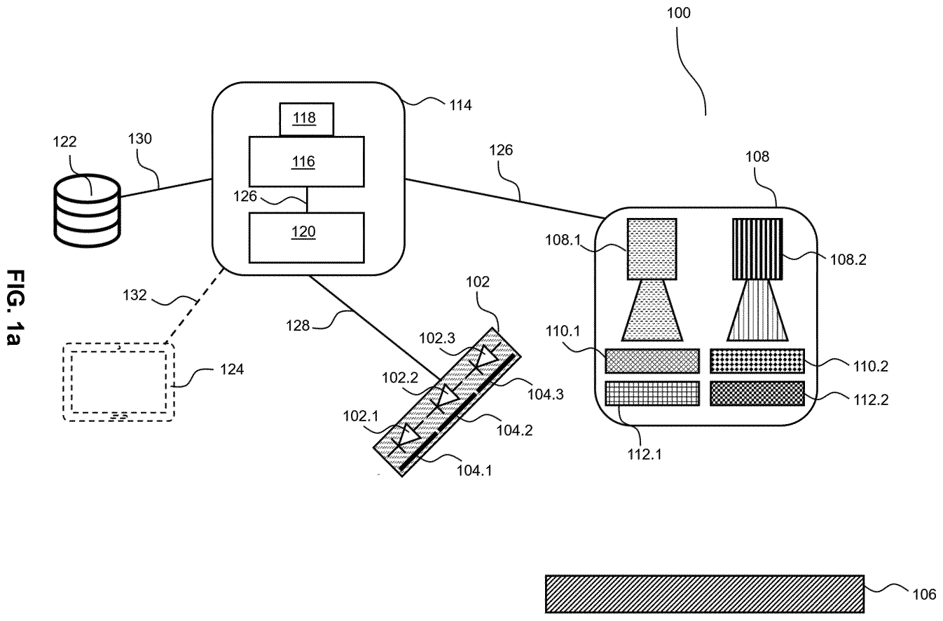

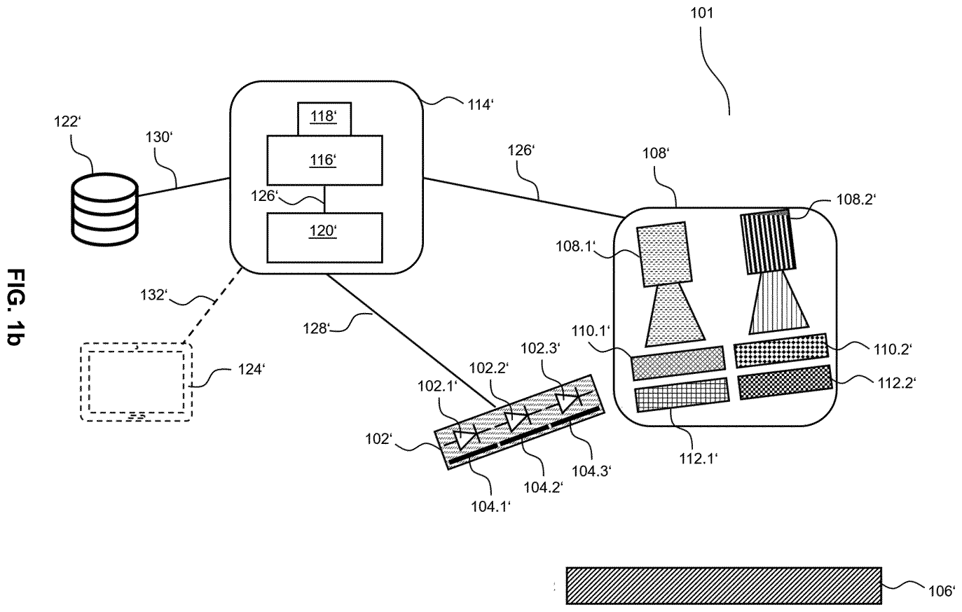

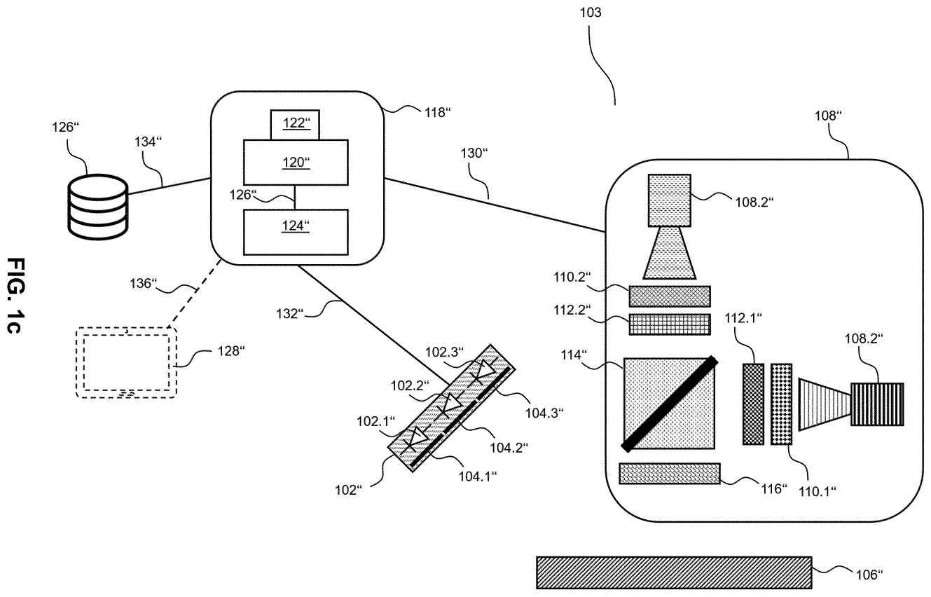

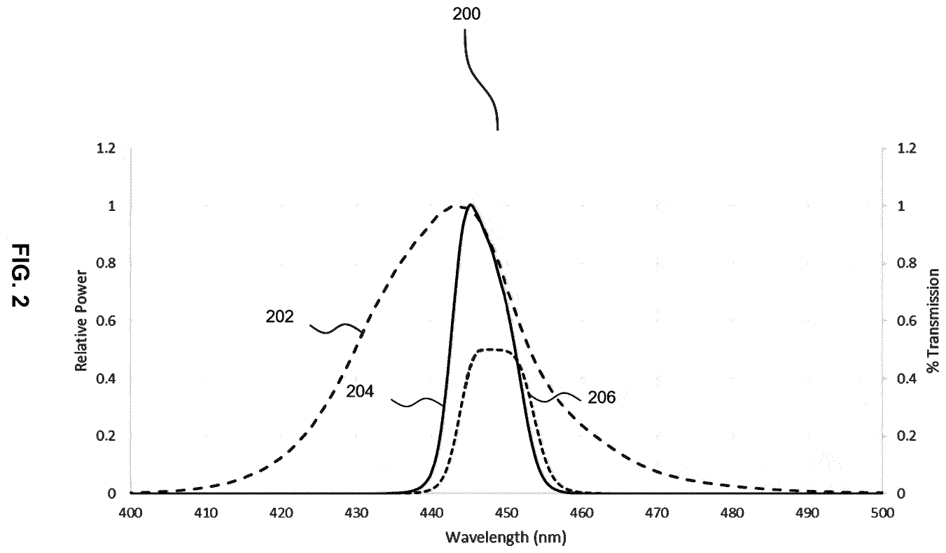

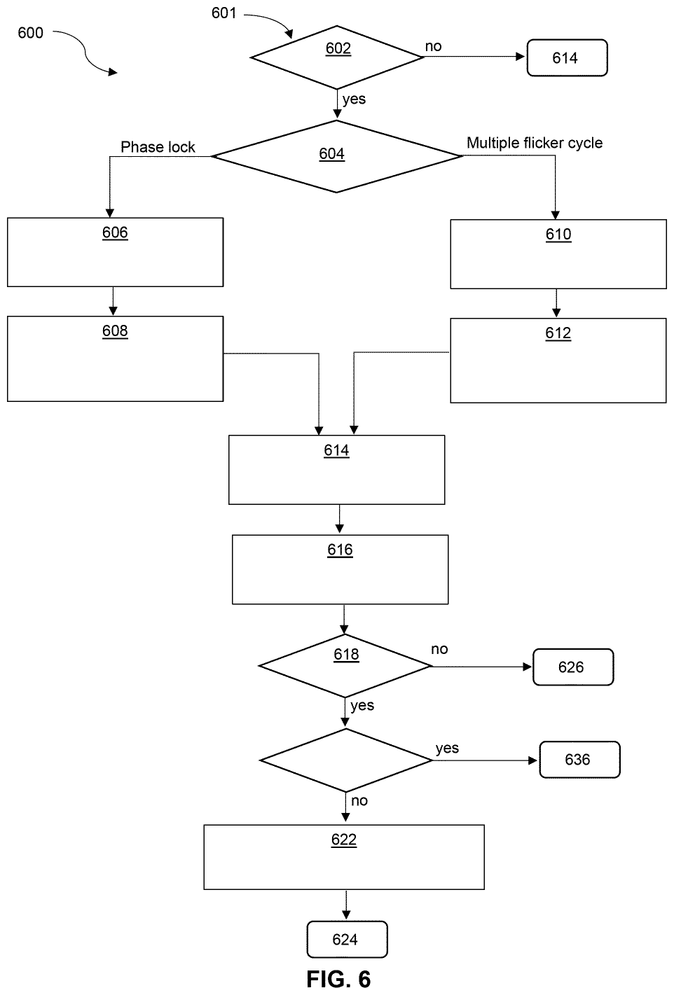

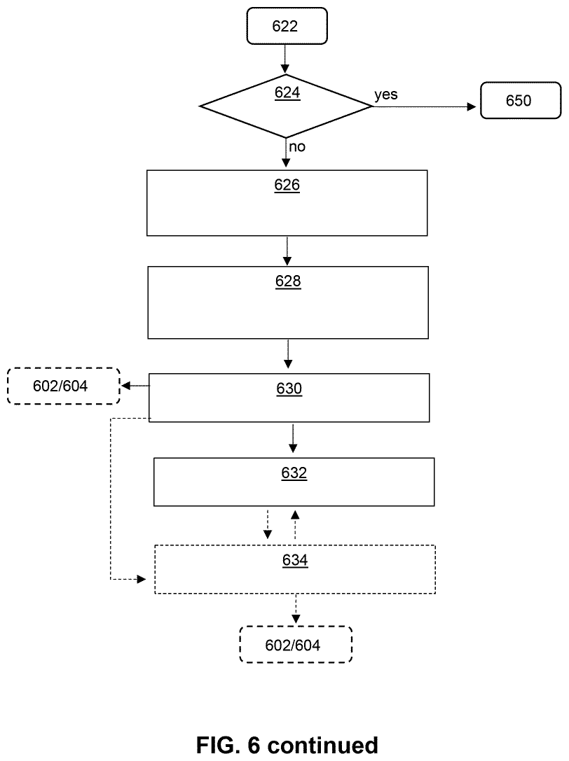

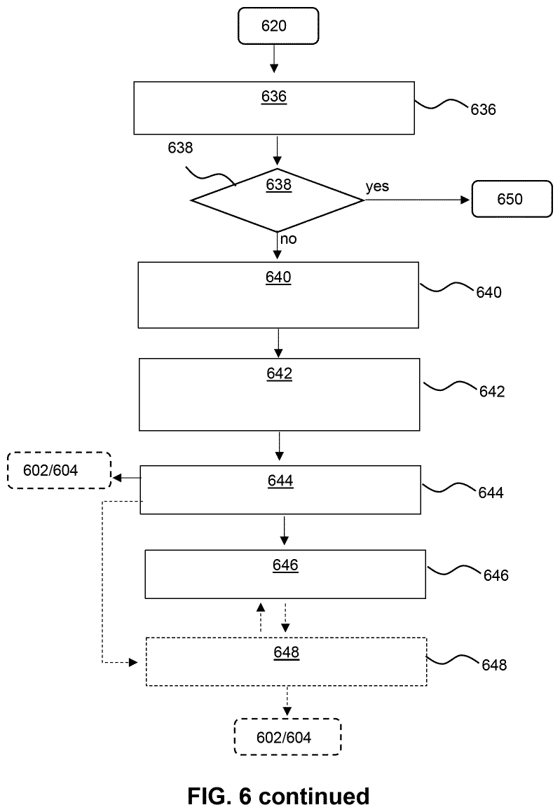

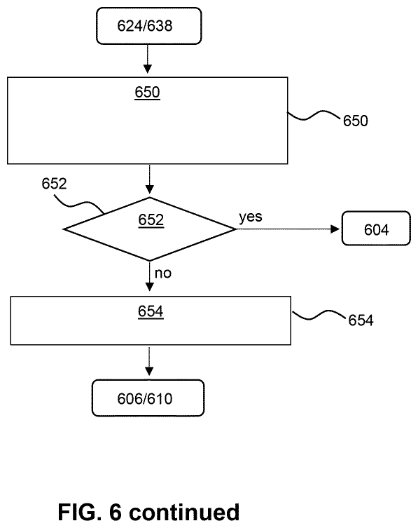

FIG. 1a illustrates a system for recognizing at least one object having object specific luminescence and/or reflectance properties in a scene in accordance with a first embodiment of the invention and may be used to implement method 600 described in relation to FIG. 6 below. System 100 comprises a light source 102 arranged in an angle of 45° with respect to the sensor unit 108. In this example, the light source has 3 different illuminants 102.1, 102.2, 102.3. In another example, the light source has up to 10 different illuminants. In this example, the illuminants are narrowband LEDs. In another example, a combination of LEDs and other illuminants, such as fluorescent and/or incandescent illuminants can be used. Each illuminant 102.1, 102.2, 102.3 of the light source comprises a bandpass filter 104.1, 104.2, 104.3 positioned optically intermediate the illuminant and the object to be recognized 106.

System 100 further comprises a sensor unit 108, which is arranged horizontally with respect to the object to be recognized 106. In this example, the sensor unit 108 comprises two color sensitive sensors 108.1, 108.2. In another example, the sensor unit 108 only comprises one color sensitive sensor. In this example, the color sensitive sensors 108.1, 108.2 are both selected from RGB color cameras. In another example, the color sensitive sensors are selected from multispectral and/or hyperspectral cameras. It is also possible to combine an RGB color camera with a multispectral and/or hyperspectral camera or vice versa. Each sensor 108.1, 108.2 comprises a camera filter 110.1, 110.2 positioned optically intermediate the sensor and the object to be recognized 106. In this example, the camera filter is a multi-bandpass filter and filters 110.1 and 110.2 are complementary to each other. In this example, each camera further comprises collection optics 112.1, 112.2 positioned optically intermediate the camera filter 110.1, 110.2 and the object to be recognized 106. The arrangement of the collection optics and the camera filter can be reversed, i.e. the collection optics can be positioned optically intermediate the sensor and the camera filter. Moreover, the sensor. The multi-bandpass filter and the collection optics shown as separate components in this example can be combined into one single sensor device (not shown).

System 100 further comprises a processing unit 114 housing computer processor 116 and internal memory 118 which is connected via communication interfaces 126, 128 to the light source 102 and the sensor unit 108. In this example, processing unit 114 further comprises control unit 118 connected via communication interface 124 to processor 114. In another example, control unit 118 is present separately from processing unit 114. The processor 114 is configured to execute instructions, for example retrieved from memory 116, and to carry out operations associated with the computer system 100, namely
optionally determine further object specific luminescence properties from the acquired data on object specific reflectance and/or luminescence properties, and
determine the object(s) based on
   the data acquired on object specific reflectance and/or luminescence properties and/or the determined further object specific reflectance and/or luminescence properties and
   the digital representations of pre-defined objects.

The processor 116 can be a single-chip processor or can be implemented with multiple components. In most cases, the processor 116 together with an operating system operates to execute computer code and produce and use data. In this example, the computer code and data resides within memory 118 that is operatively coupled to the processor 116. Memory 118 generally provides a place to hold data that is being used by the computer system 100. By way of example, memory 118 may include Read-Only Memory (ROM), Random-Access Memory (RAM), hard disk drive and/or the like. In another example, computer code and data could also reside on a removable storage medium and loaded or installed onto the computer system when needed. Removable storage mediums include, for example, CD-ROM, PC-CARD, floppy disk, magnetic tape, and a network component. The processor 116 can be located on a local computing device or in a cloud environment. In the latter case, a display device (not shown) may serve as a client device and may access the server (i.e. computing device 114) via a network.

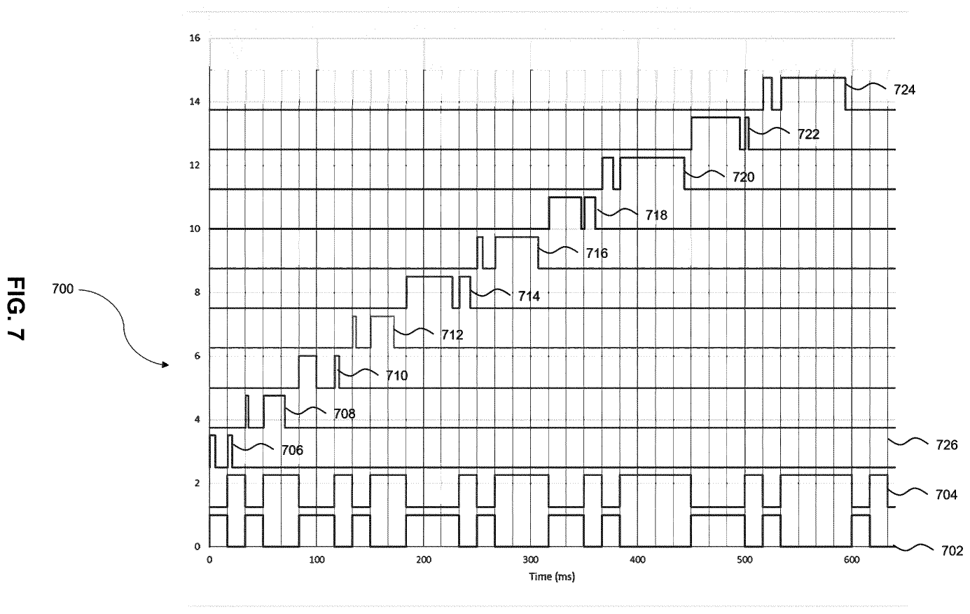

The control unit 118 is configured to control the light source 102 and/or the sensor unit 108 by switching on at least one illuminant of the light source and/or at least one sensor of the sensor unit at pre-defined time point(s) for a pre-defined duration. To ensure that each sensor 108.1, 108.2 acquires data upon illumination of the scene with at least one illuminant 102.1, 102.2, 102.3 of light source 102, control unit 118 synchronizes the switching of the illuminants 102.1, 102.2, 102.3 of light source 102 and sensors 108.1, 108.2 of sensor unit 108 as previously described (see also description of FIG. 7 below). Control unit 118 is connected to processor 116 via communication interface 126 and may be receive instructions concerning the synchronization from the processor 116.

System 100 further comprises database 122 comprising digital representations of pre-defined objects connected via communication interface 130 to processing unit 114. The digital representations of pre-defined objects stored in database 122 are used by processor 116 of processing unit 114 during the determination of the at least one object by calculating best matching luminescence and/or reflectance properties based on the retrieved digital representations and the acquired or processed data.

In one example, system 100 further comprises a display device 124 having a screen and being connected to processing unit 114 via communication interface 131. Display device 124 displays the at least one object determined by the processing device 114 and provided via communication interface 132 on its screen in particular via a graphical user interface (GUI), to the user. In this example, display device 206 is a tablet comprising a screen and being integrated with a processor and memory (not shown) to form a tablet. In another example, the screen of display device 124 may be a separate component (peripheral device, not shown). By way of example, the screen of the display device 124 may be a monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma displays and the like. In another example, system 100 may not comprise a display device 124. In this case, the recognized objects may be stored in a database or used as input data for a further processing unit (not shown).

FIG. 1b illustrates a system for recognizing at least one object having object specific luminescence and/or reflectance properties in a scene in accordance with a second embodiment of the invention and may be used to implement method 600 described in relation to FIG. 6 below. The system 101 of FIG. 1b contains the same components as described in relation to FIG. 1a, namely
a light source 102′ comprising three illuminants 102.1′, 102.2′, 102.3′ and bandpass filters 104.1′, 104.2′, 104.3′ in front of each illuminant,
a sensor unit 108′ comprising two color sensitive sensors 108.1′, 108.2′, a multi-bandpass filters 110.1′, 110.2′ and collection optics 112.1′, 112.3′,
a processing 114′ connected via communication interfaces 126′, 128′ to sensor unit 108′ and light source 102′, the processing unit 114′ comprising a processor 116′, a memory 118′ and a control unit 120′ a database 122′ containing digital representations of predefined objects and connected via communication interface 130′ to processing unit 114′ and
optionally a display device 124′ connected via communication interface 132′ to processing unit 114′.

With respect to FIG. 1a previously described the angle of the light source 102′ and sensor unit′ relative to the object to be recognized 106′ has been adjusted such that the angle between the light source 102′ and the normalized plane (e.g. the plane being vertically to the object 106′) is 20° and the angle between the sensor unit 108′ and the specular plane is 33° (see also FIG. 4). This allows to minimize specularity and thus increases accuracy of the object recognition because the specularity (i.e. the white light reflection) is undesired due to the complete loss of color information.

FIG. 1c illustrates a system for recognizing at least one object having object specific luminescence and/or reflectance properties in a scene in accordance with a third embodiment of the invention and may be used to implement method 600 described in relation to FIG. 6 below. The system 103 comprises a processing unit 118″ connected via communication interfaces 130″, 132″, 134″, 136″ to light source 102″, sensor unit 108″, database 126″ and optionally display device 128″. Processing unit 118′, database 126″ and display device 128″ correspond to the processing unit, database and display device described in relation to FIGS. 1a and 1b. Sensor unit 108″ contains the sensitive sensors 108.1″ and 108.2″ arranged in a 90° angle relative to each other (i.e. sensor 108.1″ is also arranged in a 90° angle relative to the object to be recognized 106″) In this example, each sensor 108.1″, 108.2″ contains a multi-bandpass filter 110.1″, 110.2″ and collection optics 112.1″, 112.2. In another example, each sensor 108.1″, 108.2″ does not contain the multi-bandpass filter and/or the collection optics. Sensor unit 108″ further comprises a multichroic beam splitter 114″. In this example, further collection optics 116″ are present optically intermediate the beam splitter 114″ and the object to be recognized 106″. In another example, sensor unit 108″ does not contain collection optics 116″. As previously noted, the order of multi-bandpass filter 110.1″, 110.2″ and/or collection optics 112.1″, 112.2 may be reversed or each sensor 108.1″, 108.2″, multi-bandpass filter 110.1″, 110.2″ and collection optics 112.1″, 112.2 may be configured as a single sensor device.

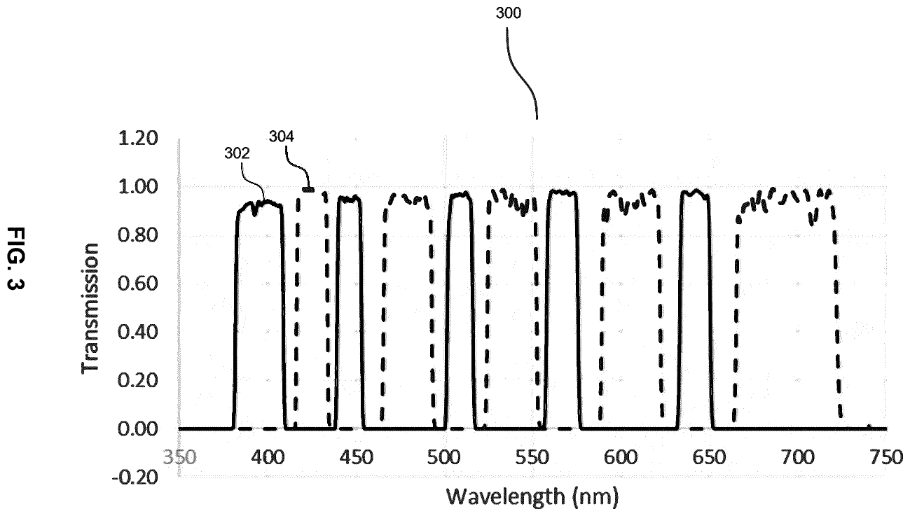

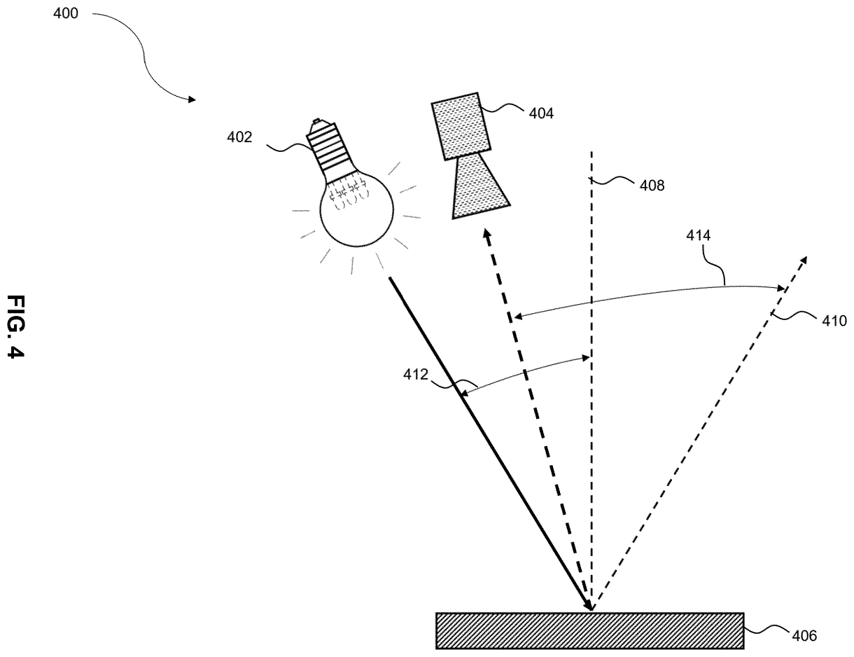

FIG. 2 shows an example 200 of light output narrowing due to a bandpass filter on an LED illuminant, such as illuminants 102.1 to 102.3, of the light source 102 described in relation to FIGS. 1a to 1c. The unfiltered output 202 of the blue LED is centered around a wavelength of 445 nm and the LED emits in a wavelength range of 410 to 490 nm. The bandpass filter selected for this LED allows transmission 206 of wavelengths of 440 to 460 nm. Use of this bandpass filter in front of the blue LED results in an output 204 of the blue LED which has a significantly narrower FWHM (FWHM=10 nm) than the unfiltered output of the LED (FWHM=35 nm).

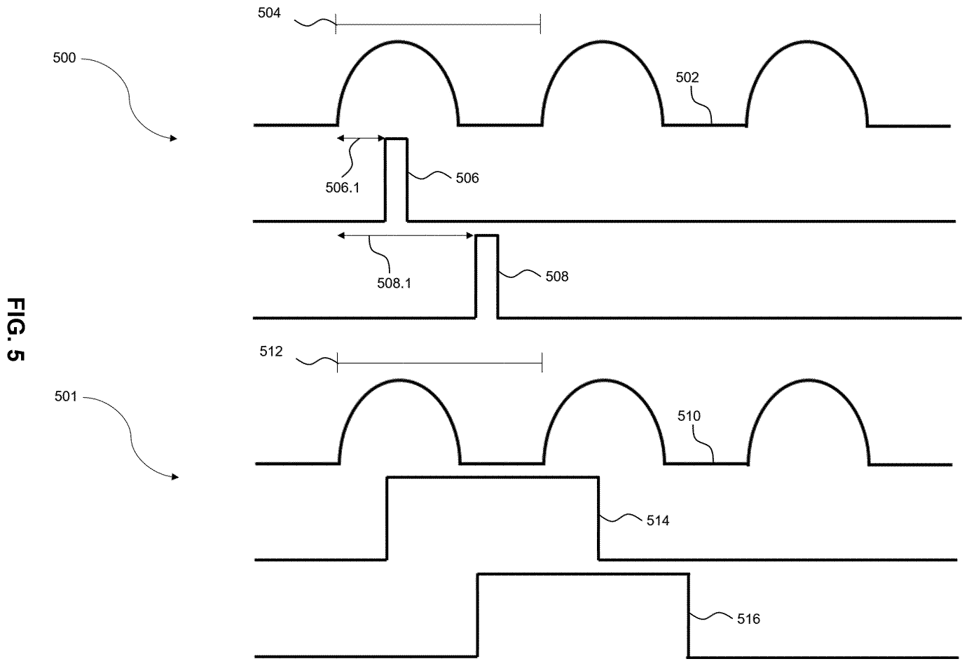

FIG. 3 shows a transmission profile 300 of two complementary multi-bandpass filters 302, 304, for example multi-bandpass filters 110.1, 110.2 described in relation to FIGS. 1a to 1c. The multi-bandpass filters are positioned optically intermediate the color sensitive sensor and the object to be recognized in the scene and selectively block defined wavelength. They are selected such that the match to the bandpass filters in front of each illuminant so that a physical separation of reflected and fluorescent light is achieved as previously described.

FIG. 4 shows a preferred geometry 400 for the inventive system which is designed to avoid specularity. Specularity is not desirable during object recognition because the specularity is a pure white reflection which is devoid of any color information that is used for object recognition and thus decreases the accuracy of the object recognition. The system contains a light source 402 and a sensor unit 404, for example the light source and sensor units described in relation to FIGS. 1a to 1c. The light source 402 is arranged in an angle of 20° (412) relative to the normal plane 408 of the object to be recognized 406. The sensor unit 404 is arranged in an angle of 33° (414) relative to the specular plane 410 (assumed to have an angle of 0°).

FIG. 5. Illustrates the influence of the ambient light flicker contribution for different sensor exposure times. In the first scenario 500, the sensor exposure time 506 is short compared to each cycle 504 of the ambient light flicker 502. When the exposure time is very short compared with the flicker period and the flicker goes from bright (100% on) to fully dark (0% on), the ambient light contribution can vary by 100% depending on when in the flicker cycle the exposure begins. For sensor exposure time 506, the ambient flicker has the maximum (100%) contribution to the image, whereas for sensor exposure time 508, the ambient flicker has minimum contribution (0%) to the image. The significantly different contribution of ambient flicker to the acquired image is due to the different the timing (i.e. the phase) 508.1 of the sensor exposure time 508 with respect to the timing 510.1 of the sensor exposure time 510. To avoid the variation in the contribution of the ambient light flicker, the sensor exposure time may be set to a defined phase, i.e. a phase-locking as previously described may be performed. After phase-locking, each sensor exposure time starts exactly at the same phase and thus acquires exactly the same contribution of the ambient light flicker. This allows to reliably obtain the contribution of the illumination from the light source to the acquired images upon performing the delta-calculation as previously described.

In the second scenario 501, exposure times 514, 516 being equal to the flicker cycle 512 of the ambient flicker 510 are chosen. In this case, all parts of the flicker contribute equally to the image even though the timing (phase) differs. Following the same principle, any whole multiple of the flicker cycle will also result in an identical flicker contribution regardless of the phase of the exposure. Setting the sensor exposure duration to the flicker cycle 512 or a whole multiple of the flicker cycle (to capture more than one flicker cycle) also allows to acquire the same contribution of the ambient light flicker in each image and thus allows to perform the object recognition with a high accuracy under ambient light conditions.

FIG. 6 depicts a non-limiting embodiment of a method 600 for recognizing at least one object having object specific luminescence and/or reflectance properties in a scene. In this example, the object to be recognized is imparted with luminescence by use of a fluorescent coating on the surface of the object and the scene is located indoors. In another example, the scene may be located outdoors. In this example, a display device is used to display the determined objects on the screen, in particular via a GUI.

In block 102 of method 600, routine 601 determines whether ambient light compensation (ALC) is to be performed, i.e. whether the flickering associated with commonly used light sources is to be compensated. This will normally be the case if method 600 is to be performed indoors. If it is determined that ALC is to be performed, routine 601 proceeds to block 604, otherwise routine 601 proceeds to block 614 described later on.

In block 604, routine 601 determines whether the ambient light compensation is to be performed using phase-locking (i.e. setting the switch on of each sensor to a pre-defined time point) or is to be performed using a multiple of the flicker cycle. This determination may be made according to the programming of the processor. In one example, a pre-defined programming is used, for example if the illumination setup of the scene is known prior to installation of the object recognition system. In another example, the processor determines whether the illuminants present in the scene use PWM LED illumination, for example by connection to the illuminants via Bluetooth to retrieve their configuration. In case routine 601 determines in block 604 that phase-locking is to be performed, it proceeds to block 606, otherwise it proceeds to block 610.

In block 606, routine 601 determines and sets the phase-lock for each color sensitive sensor of the sensor unit. This may be accomplished by determining the light variation or the line voltage fluctuation present in the scene using the method previously described. Normally, the flicker cycle of commonly used illuminations depends on the utility frequency present at the scene. If a 60 Hz utility frequency is used, the frequency of the flicker cycle will be 120 Hz. If a 50 Hz utility frequency is used, the flicker cycle will be 100 Hz. In one example, phase lock is performed relative to the light variation or relative to the line voltage fluctuation.

After the phase-lock is set for each color sensitive sensor (i.e. after defined acquisition time points for switching on each color sensor have been determined), routine 601 proceeds to block 608.

In block 608, routine 601 determines and sets the acquisition duration for each color sensitive sensor and the illumination duration for each illuminant. The acquisition and illumination durations may be determined as previously described, for example by using the method described in relation with the processing unit of the inventive system. The setting may be performed according to pre-defined values which may be provided to routine 601 from an internal storage or a database. In case the method is repeated, the determination may be made based on previously acquired sensor data and object recognition accuracy. In case two color sensitive sensors are used, each illuminant may be switched on when each color sensitive sensor is switched on. If each color sensitive sensor is switched on sequentially, then each illuminant may be switched on twice during each lightning cycle. The illumination duration is set to achieve a reasonable measurement within the range of the respective color sensitive sensor, while leaving room for effect of the additional ambient lighting. Typically, a shorter illumination duration for the color sensitive sensor measuring reflectance+luminescence is needed as compared to the color sensitive sensor measuring luminescence only, as the measurement for the reflectance+luminescence contains the reflected light from the illuminator(s), and reflection is typically much stronger than luminescence. In case each illuminant is switched on twice, the illumination duration of each switch-on may therefore vary (see also FIG. 7).

In block 610, routine 601 determines and sets fixed acquisition durations for each color sensitive sensor. The acquisition durations may be determined as previously described, for example by using the method described in relation with the processing unit of the inventive system. The fixed acquisition durations may be adapted to the flicker cycle present in the scene. For a 60 Hz utility frequency having a flicker of 120 Hz, acquisition durations of 1/60, 2/60, 3/60 and 4/60 of a second may be used. For a 50 Hz utility frequency having a flicker of 100 Hz, acquisition durations of 1/50, 2/50, 3/50 and 4/50 of a second may be used. The defined acquisition durations may either be preprogrammed or may be retrieved by routine 601. Retrieving the defined acquisition durations may include determining the utility frequency used in the scene, the type of color sensitive sensors of the sensor device and the type of illuminants of the light source and retrieving the defined acquisition durations associated with the determined utility frequency and the determined type of color sensitive sensors and illuminants from a storage medium, such as the internal storage or a database.

In block 612, routine 601 determines and sets the defined acquisition time points to switch on each color sensitive sensor and the illumination duration for each illuminant. This determination may be made as previously described in relation to block 608.

In block 614, routine 601 determines and sets the sequence of each illuminant and each sensor (i.e. in which order each illuminant and each color sensitive sensor are switched on and off. Routine 601 may determine the sequence based on pre-defined criteria, such a specific order based on the wavelength of the illuminants or it may be arbitrarily select the order. Based on the order of the illuminates, routine 601 may either determine the order of each color sensitive sensor or may use a pre-defined order, for example sequential order of the color sensitive sensors (see for example FIG. 7).

In block 616, routine 601 instructs the light source to illuminate the scene with the illuminants and to acquire data on object specific luminescence and/or reflectance properties according to the settings made in blocks 606, 608 and 614 or 610, 612, 614. The acquired data may be stored on an internal memory of the sensor unit or may be stored in a database which is connected to the sensor unit via a communication interface.

In block 618, routine 601 determines whether further processing of the acquired data, for example delta calculation, identification of luminescence regions and transformation of RGB values into rg chromacity values or determination of luminescence/reflectance patterns is to be performed. If this is the case, routine 601 proceeds to block 620, otherwise routine 601 proceeds to block 626 described later on. The determination may be made based on the programming and may depend, for example, on the data present in the digital representations of pre-defined objects used to determine the objects or on the measurement conditions (i.e if ALC is required)

In block 620, routine 601 determines whether the further processing is to be performed remotely, i.e. with a further processing device being present separately from the processor implementing routine 601. This may be preferred if the processing requires a large computing power. If routine 601 determines in block 620 that the further processing is to be done remotely, it proceeds to block 638, otherwise it proceeds to block 622.

In block 622, routine 601 determines further luminescence and/or reflectance properties as previously described by determining differential data (i.e. performing the delta-calculation previously described), identifying luminescence regions in the differential data and transforming the RGB values in the data image into rg chromacity values and/or determining the luminescence and/or reflectance spectral patterns. The processed data may be stored on a data storage medium, such as the internal storage or a database prior to further processing.

In block 624, routine 601 determines whether to perform a flicker analysis or flicker measurement. If this is the case, routine 601 proceeds to block 652, otherwise it proceeds to block 626.

In block 626, routine 601 retrieves at least one digital representation of a pre-defined object from a data storage medium, such as a database. The database is connected to the processor implementing routine 601 via a communication interface.

In block 628, routine 601 determines at least one object based on the retrieved digital representations and the further luminescence and/or reflectance properties determined in block 622 or the data acquired in block 616. For this purpose, routine 601 may calculate the best matching luminescence and/or reflectance properties by using any number of previously described matching algorithm on the data contained in the retrieved digital representations and the processed data. The object assigned to the best matching properties may then be obtained directly from the retrieved digital representation or may be retrieved from a further database based on the best matching properties as previously described.

In block 630, routine 601 provides the determined object(s) to a display device. The display device is connected via a communication interface to the processor implementing routine 601. The processor may provide further data associated with the determined object(s) for display on the screen, such as further data contained in the retrieved digital representation or further data retrieved from a database based on the determined object(s). Routine 601 may then proceed to block 602 or block 604 and repeat the object recognition process according to its programming. Monitoring intervals of the scene may be pre-defined based on the situation used for object recognition or may be triggered by pre-defined events, such as entering or leaving of the room.

In block 632, the display device displays the data received from the processor in block 630 on the screen, in particular within a GUI.

In block 634, routine 601 may determine actions associated with the determined objects and may display these determined actions to the user in block 632. The determined actions may be pre-defined actions as previously described. In one example, the determined actions may be performed automatically be routine 601 without user interaction. However, the routine 601 may provide information about the status of the initiated action to the user in block 632. In another example, a user interaction is required after displaying the determined actions in block 632 on the screen of the display device prior to initiating any action by routine 601 as previously described. Routine 601 may be programmed to control the initiated actions and to inform the user on the status of the initiated actions. After the end of block 634, routine 601 may return to block 602 or 604 as previously described.

In block 636, routine 601 provides the data acquired in block 616 to the further processing device which is connected with the processor implementing routine 601 via a communication interface.

In block 638, the further processor determines whether a flicker analysis is to be performed as described in relation to block 624.

In block 640, routine 601 retrieves at least one digital representation of a pre-defined object from a data storage medium, such as a database as described in relation to block 626.

In block 642, routine 601 determines at least one object based on the retrieved digital representations and the further luminescence and/or reflectance properties determined in block 622 or the data acquired in block 616 as described in relation to block 628

In block 644, routine 601 provides the determined object(s) to a display device as described in relation to block 630. After the end of block 644, routine 601 may return to block 602 or 604 as previously described.

In block 646, the display device displays the data received from the processor in block 644 on the screen, in particular within a GUI, as described in relation to block 632.

In block 648, routine 601 determines actions associated with the determined objects and displays these determined actions to the user in block 646 as described in relation to block 634. After the end of block 648, routine 601 may return to block 602 or 604 as previously described.

In block 650, routine 601 or the further processing device determines the effectiveness of flicker mitigation by comparing background images acquired at different measurement times.

In block 652, routine 601 or the further processing device determines whether of flicker mitigation is satisfactory, for example by determining the ambient flicker contribution in the images and comparing the determined ambient flicker contribution to a pre-defined threshold value stored on a data storage medium. If the mitigation is satisfactory, routine 601 proceeds to block 604, otherwise routine 601 proceeds to block 654.

In block 654, routine 601 or the further processing device determines new phase-locking or multiples of the flicker cycle based on the results of block 650. The new phase-lock or multiples are then used in blocks 606 or 610.

FIG. 7 shows a diagram 700 for synchronizing the switching of two color sensitive sensors 702, 704 of the sensor unit and ten LED illuminants 706 to 724 by switching on each color sensitive sensor for a whole number multiple of the 120 Hz flicker cycle (1/60, 2/60, 3/60 and 4/60 of a second) and synchronizing the switching of each LED illuminant to the pre-defined time duration of each sensor for purposes of ambient light compensation for light sources that may have flicker. The diagram can be used to implement the systems of FIG. 1a to 1c or the method of FIG. 6. The method used for synchronizing is to set the color sensitive exposure times to a defined multiple of the flicker cycle and to adjust the illumination period of each illuminant taking into account that the measurement of fluorescence only needs more time than the measurement of the fluorescence and reflectance channel. The illumination “on” period of each illuminant is delayed for ˜ 0.5 ms to avoid issues with the initial readings of each color sensitive sensor. Each illuminant is switched on twice to allow sensor reading with both sensors without overlapping sensor exposure times. The current system cycles through the LED illuminators in order from the shortest to longest wavelength, capturing images for each sensor sequentially. After the images for each LED and sensor are obtained, the system then obtains the background images for each sensor at the 1/60, 2/60, 3/60, and 4/60 of a second integration times. The delta calculation can the be performed by subtracting the respective background image from the appropriate LED illuminator “on” images to yield the corrected image. By capturing images using this method and performing the delta calculation, common sources of indoor lighting flicker can be accounted for with the reflective light blocking fluorescence measurement system, such as the system illustrated in FIG. 1b.

The following tables lists the sensor time as well as the timing for each illuminant of the system:

| Time (ms) | Sensor 1 | Time (ms) | Sensor 2 |
|---|---|---|---|
| 0 | OFF | 0 | OFF |
| 0 | OFF | 16.66692 | OFF |
| 0 | ON | 16.66692 | ON |
| 16.66692 | ON | 33.33384 | ON |
| 16.66692 | OFF | 33.33384 | OFF |
| 33.33384 | OFF | 50.00076 | OFF |
| 33.33384 | ON | 50.00076 | ON |
| 50.00076 | ON | 83.3346 | ON |
| 50.00076 | OFF | 83.3346 | OFF |
| 83.3346 | OFF | 116.6684 | OFF |
| 83.3346 | ON | 116.6684 | ON |
| 116.6684 | ON | 133.3354 | ON |
| 116.6684 | OFF | 133.3354 | OFF |
| 133.3354 | OFF | 150.0023 | OFF |
| 133.3354 | ON | 150.0023 | ON |
| 150.0023 | ON | 183.3361 | ON |
| 150.0023 | OFF | 183.3361 | OFF |
| 183.3361 | OFF | 233.3369 | OFF |
| 183.3361 | ON | 233.3369 | ON |
| 233.3369 | ON | 250.0038 | ON |
| 233.3369 | OFF | 250.0038 | OFF |
| 250.0038 | OFF | 266.6707 | OFF |
| 250.0038 | ON | 266.6707 | ON |
| 266.6707 | ON | 316.6715 | ON |
| 266.6707 | OFF | 316.6715 | OFF |
| 316.6715 | OFF | 350.0053 | OFF |
| 316.6715 | ON | 350.0053 | ON |
| 350.0053 | ON | 366.6722 | ON |
| 350.0053 | OFF | 366.6722 | OFF |
| 366.6722 | OFF | 383.3392 | OFF |
| 366.6722 | ON | 383.3392 | ON |
| 383.3392 | ON | 450.0068 | ON |
| 383.3392 | OFF | 450.0068 | OFF |
| 450.0068 | OFF | 500.0076 | OFF |
| 450.0068 | ON | 500.0076 | ON |
| 500.0076 | ON | 516.6745 | ON |
| 500.0076 | OFF | 516.6745 | OFF |
| 516.6745 | OFF | 533.3414 | OFF |
| 516.6745 | ON | 533.3414 | ON |
| 533.3414 | ON | 600.0091 | ON |
| 533.3414 | OFF | 600.0091 | OFF |
| 600.0091 | OFF | 616.676 | OFF |
| 600.0091 | ON | 616.676 | ON |
| 616.676 | ON | 633.343 | ON |
| 616.676 | OFF | 633.343 | OFF |

| Time (ms) | LED 1 | Time (ms) | LED₂ | Time (ms) | LED₃ | Time (ms) | LED₄ |
|---|---|---|---|---|---|---|---|
| 0 | OFF | 0 | OFF | 0 | OFF | 0 | OFF |
| 0.49752 | OFF | 33.83136 | OFF | 83.83212 | OFF | 133.8329 | OFF |
| 0.49752 | ON | 33.83136 | ON | 83.83212 | ON | 133.8329 | ON |
| 5.47272 | ON | 36.31896 | ON | 99.75276 | ON | 136.818 | ON |
| 5.47272 | OFF | 36.31896 | OFF | 99.75276 | OFF | 136.818 | OFF |
| 17.16444 | OFF | 50.49828 | OFF | 117.166 | OFF | 150.4998 | OFF |
| 17.16444 | ON | 50.49828 | ON | 117.166 | ON | 150.4998 | ON |
| 21.1446 | ON | 70.39908 | ON | 121.1461 | ON | 172.3907 | ON |
| 21.1446 | OFF | 70.39908 | OFF | 121.1461 | OFF | 172.3907 | OFF |

| Time (ms) | LED 5 | Time (ms) | LED 6 | Time (ms) | LED 7 | Time (ms) | LED 8 |
|---|---|---|---|---|---|---|---|
| 0 | OFF | 0 | OFF | 0 | OFF | 0 | OFF |
| 183.8336 | OFF | 250.5013 | OFF | 317.169 | OFF | 367.1698 | OFF |
| 183.8336 | ON | 250.5013 | ON | 317.169 | ON | 367.1698 | ON |
| 226.8691 | ON | 255.4765 | ON | 347.269 | ON | 377.1202 | ON |
| 226.8691 | OFF | 255.4765 | OFF | 347.269 | OFF | 377.1202 | OFF |
| 233.8344 | OFF | 267.1682 | OFF | 350.5028 | OFF | 383.8367 | OFF |
| 233.8344 | ON | 267.1682 | ON | 350.5028 | ON | 383.8367 | ON |
| 243.7848 | ON | 307.2186 | ON | 360.4532 | ON | 443.7878 | ON |
| 243.7848 | OFF | 307.2186 | OFF | 360.4532 | OFF | 443.7878 | OFF |

| Time (ms) | LED 9 | Time (ms) | LED 10 |
|---|---|---|---|
| 0 | OFF | 0 | OFF |
| 450.5044 | OFF | 517.172 | OFF |
| 450.5044 | ON | 517.172 | ON |
| 495.5299 | ON | 525.1324 | ON |
| 495.5299 | OFF | 525.1324 | OFF |
| 500.5051 | OFF | 533.839 | OFF |
| 500.5051 | ON | 533.839 | ON |
| 503.4902 | ON | 593.7901 | ON |
| 503.4902 | OFF | 593.7901 | OFF |

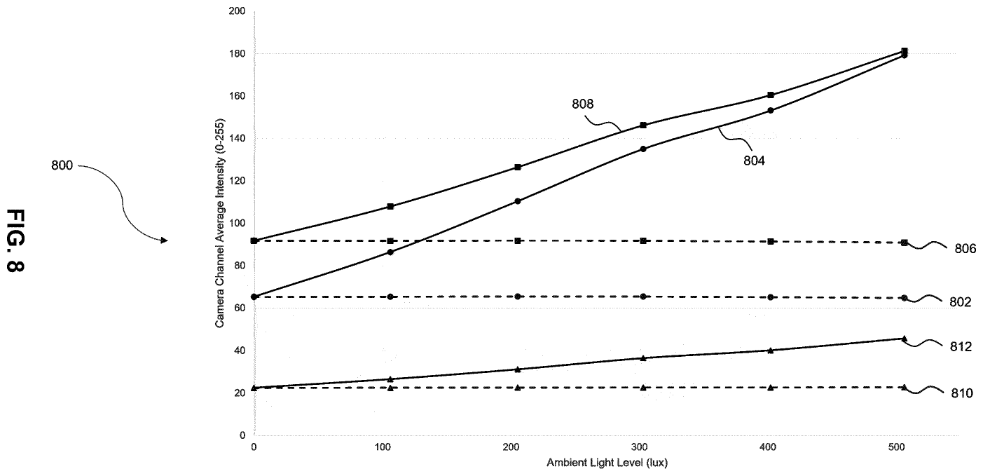

FIG. 8 shows a diagram 800 illustrating the influence of increasing amounts of ambient lighting on the average channel intensity of each RGB channel before and after performing the ambient light compensation described previously. In this example, two color sensitive sensors and 8 LED illuminants are arranged as shown in FIG. 1b and synchronization of said sensors and LED illuminants is performed as described in FIG. 7. In another example, a different arrangement of sensors and LEDs is used, such as the system of FIG. 1a or 1c.

The color sensitive cameras were Teledyne FLIR Blackfly S USB3 cameras model BFS-U3-16S2C-CS, equipped with Fujinon HF12.5HA-1S lenses. The cameras were further equipped with Chroma Technology Corporation (Bellows Falls, Vermont, USA) multi bandpass filters, one with model ZET405/445/514/561/640x and the other with model ZET405/445/514/561/640m. The illumination was provided by LEDs from LumiLeds (San Jose, California, USA) in a custom enclosure. The LEDs were equipped with bandpass filters from Thorlabs Inc. (Newton, New Jersey, USA). The 8 LEDs were the Luxeon UV U Line 425 LED (part number LHUV-0425-0600) and the Luxeon Z Color Line Royal Blue, Blue, Cyan, Green, Lime, PC Amber, Red, and Deep Red LEDs (part numbers LXZ1-PR01, LXZ1-PB01, LXZ1-PE01, LXZ1-PM01, LXZ1-PX01, LXZ1-PL02, LXZ1-PD01, and LXZ1-PA01). The 8 corresponding bandpass filters were FB420-10, FB450-10, FB470-10, FL508.5-10, FL532-10, FB570-10, FB600-10, and FL635-10, where the first number gives the approximate center of the bandpass filter in nm and the second number gives the approximate full-width-at-half-max (FWHM) for the filter in nm. The cameras and LEDs were controlled by a custom LabVIEW software program (NI, Austin, Texas, USA). All camera readings were converted to 8-bit images. Diffuse ambient lighting was provided by a SunLight 400 Lumen Rechargeable Handheld Color Match Light—CRI 97 (Astro Pneumatic Tool Co., South El Monte, California, USA). Ambient light levels at the sample were measured with a Extech Instruments LT45 light meter (Nashua, New Hampshire, USA). The sample was Pantone 803C, a fluorescent yellow color that is available from Pantone LLC (Carlstadt, New Jersey, USA). Samples were measured in the dark (˜0.1 lux) and at approximately 100, 200, 300, 400, and 500 lux light levels to simulate common indoor residential conditions.

FIG. 8 shows the average channel intensities for each RGB channel upon illumination of the scene with the Royal Blue LED and the camera recording luminescence from the scene, where the reflected light from the Royal Blue LED is blocked by the multi bandpass filter ZET405/445/514/561/640m. As can be seen from FIG. 8, ambient light compensation (i.e. synchronizing the sensors and LED illuminants as described in FIG. 7 and performing delta calculation on the acquired images as described previously) results in little change in the average intensity of the R channel (802), the G channel (806) and the B channel (810) if the amount of ambient lighting is increased from 0 lux to 500 lux. In contrast, the average intensity of the R channel (804), the G channel (808) and the B channel (812) significantly increases upon increasing amounts of ambient lighting if no ambient light compensation (i.e. delta calculation) is performed. Using the synchronization described in FIG. 7 and performing delta calculation on the acquired images thus allows to compensate common sources of indoor lighting and allows to reliably determine—with the inventive system—the object present in the scene based on its fluorescence irrespective of the amount of ambient lightning being present in the scene.

1. A system for object recognition, said system comprising:
a light source configured to illuminate a scene in which at least one object having object specific reflectance and/or luminescence properties is present, wherein the light source comprises at least one illuminant;
a sensor unit for acquiring data on object specific reflectance and/or luminescence properties upon illumination of the scene by the light source for each object having object specific reflectance and/or luminescence properties and being present in the scene, wherein the sensor unit includes at least one color sensitive sensor and at least one camera filter selectively blocking the reflected light and allowing passage of reflectance and/or luminescence originating from illuminating the scene with the light source into the at least one color sensitive sensor, the at least one camera filter being positioned optically intermediate the scene and the color sensitive sensor(s);
a data storage medium comprising a plurality of digital representations of pre-defined objects;
and a processing unit in communication with the sensor unit and the light source, the processing unit programmed to:
optionally determine further object specific luminescence properties from the acquired data on object specific reflectance and/or luminescence properties, and
determine the object(s) based on
the data acquired on object specific reflectance and/or luminescence properties and/or the determined further object specific reflectance and/or luminescence properties and
the digital representations of pre-defined objects.

2. The system according to claim 1, wherein the at least one illuminant comprises at least one LED, or wherein all illuminants comprise at least one LED.

3. The system according to claim 1, wherein each camera filter of the sensor unit is matched to spectral light emitted by the illuminant(s) of the light source.

4. The system according to claim 1, wherein the digital representation of each pre-defined object comprises pre-defined object specific reflectance and/or luminescence properties optionally associated with the object.

5. The system according to claim 1, wherein the processing unit is programmed to determine the further object specific reflectance and/or luminescence properties from the data acquired on object specific reflectance and/or luminescence properties by
generating differential data by subtracting data of the scene acquired by at least one color sensitive sensor under ambient lightning and data of the scene acquired by at least one color sensitive sensor under ambient lightning and illumination by the light source,
determining the regions of luminescence in the generated differential data and
transforming the RGB values of the differential data into rg chromacity values or determining the luminescence spectral pattern and/or the reflective spectral pattern for the determined regions of luminescence.

6. The system according to claim 1, wherein the processing unit is programmed to determine the object(s) based on the data acquired on object specific reflectance and/or luminescence properties and/or the optionally determined further object specific reflectance and/or luminescence properties and the digital representations of pre-defined objects by calculating the best matching reflectance and/or luminescence properties and obtaining the object(s) assigned to the best matching reflectance and/or luminescence properties.

7. The system according to claim 1, further comprising a control unit configured to control the light source and/or the sensor unit.

8. The system according to claim 7, wherein the control unit is configured to control the light source by switching on and off the at least one illuminant of the light source at at least one defined illumination time point for a defined illumination duration.

9. The system according to claim 7, wherein the control unit is configured to control the sensor unit by switching on and off the at least one color sensitive sensor at defined acquisition time points and/or under defined lighting conditions for a defined acquisition duration.

10. The system according to claim 9, wherein the defined acquisition time points and/or the defined acquisition durations are dependent on the flicker cycle of the ambient light sources present in the scene.

11. The system according to claim 10, wherein the defined acquisition time points are set via phase-locking such that each color sensitive sensor is always switched on at the same part of the flicker cycle.

12. The system according to claim 10, wherein the defined acquisition duration corresponds to a whole number integer multiple of the flicker cycle.

13. The system according to claim 12, wherein the whole number integer multiple of the flicker cycle is 1/60 of a second and/or 2/60 of a second and/or 3/60 of a second and/or 4/60 of a second or wherein the whole number integer multiple of the flicker cycle is 1/50 of a second and/or 2/50 of a second and/or 3/50 of a second and/or 4/50 of a second.

14. A computer-implemented method for recognizing at least one object having specific luminescence properties in a scene, the method comprising:
(i) illuminating—with a light source comprising at least one illuminant—the scene in which the least one object having object specific reflectance and/or luminescence properties is present, wherein each illuminant of the light source has a full-width-half-max (FWHM) of 1 to 50 nm,
(ii) acquiring—with a sensor unit—data on the object specific reflectance and/or luminescence properties upon illuminating the scene with the light source for each object having object specific reflectance and/or luminescence properties and being present in the scene, wherein the sensor unit includes at least one color sensitive sensor and at least one camera filter selectively blocking the reflected light and allowing passage of reflectance and/or luminescence originating from illuminating the scene with the light source into the at least one color sensitive sensor, the at least one camera filter being positioned optically intermediate the scene and the sensor(s);
(iii) optionally determining—with a computer processor—further object specific reflectance and/or luminescence properties from the data acquired in step (ii);
(iv) providing to the computer processor via a communication interface digital representations of pre-defined objects;
(v) determining—with the computer processor—the object(s) based on data acquired on object specific reflectance and/or luminescence properties and/or the optionally determined further object specific reflectance and/or luminescence properties and the provided digital representations of pre-defined objects, and
(vi) optionally providing via a communication interface the determined object(s).

15. A non-transitory computer-readable storage medium, the computer-readable storage medium including instructions that when executed by a computer, cause the computer to perform the steps according to the method of claim 14.

16. The system according to claim 1, wherein the at least one illuminant comprises at least one narrowband LED, or wherein all illuminants comprise at least one are narrowband LED.
